(19) United States
(12) Patent Application Publication
(10) Pub. No.: US 2022/0193906 A1
(43) Pub. Date: Jun. 23, 2022

(54) User Interface for Supervised Autonomous Grasping

(71) Applicant: Boston Dynamics, Inc., Waltham, MA (US)

(72) Inventors: Andrew James Barry, Cambridge, MA (US); Alfred Anthony Rizzi, Waltham, MA (US)

(73) Assignee: Boston Dynamics, Inc., Waltham, MA (US)

(21) Appl. No.: 17/645,042

(22) Filed: Dec. 17, 2021

Related U.S. Application Data
(60) Provisional application No. 63/128,768, filed on Dec. 21, 2020.

(51) Int. Cl. B25J 9/16; B25J 13/06

(52) U.S. Cl. CPC B25J 9/1664; B25J 9/1661; B25J 13/06; B25J 9/1697

(57) ABSTRACT

A computer-implemented method, executed by data processing hardware of a robot, includes receiving sensor data for a space within an environment about the robot. The method includes receiving, from a user interface (UI) in communication with the data processing hardware, a user input indicating a user-selection of a location within a two-dimensional (2D) representation of the space. The location corresponds to a position of a target object within the space. The method includes receiving, from the UI, a plurality of grasping inputs designating an orientation and a translation for an end-effector of a robotic manipulator to grasp the target object. The method includes generating a three-dimensional (3D) location of the target object based on the received sensor data and the location corresponding to the user input. The method includes instructing the end-effector to grasp the target object using the generated 3D location and the plurality of grasping inputs.

### CROSS REFERENCE TO RELATED APPLICATIONS

This U.S. patent application claims priority under 35 U.S.C. § 119(e) to U.S. Provisional Application 63/128,768, filed on Dec. 21, 2020. The disclosure of this prior application is considered part of the disclosure of this application and is hereby incorporated by reference in its entirety.

### TECHNICAL FIELD

This disclosure relates to a user interface for supervised autonomous grasping.

### BACKGROUND

A robot is generally defined as a reprogrammable and multifunctional manipulator designed to move material, parts, tools, or specialized devices through variable programmed motions for a performance of tasks. Robots may be manipulators that are physically anchored (e.g., industrial robotic arms), mobile robots that move throughout an environment (e.g., using legs, wheels, or traction based mechanisms), or some combination of a manipulator and a mobile robot. Robots are utilized in a variety of industries including, for example, manufacturing, transportation, hazardous environments, exploration, and healthcare. As such, the ability to program robots in a quick and an efficient manner for various behaviors provides additional benefits to such industries.

### SUMMARY

One aspect of the disclosure provides a computer-implemented method that, when executed by data processing hardware of a robot causes the data processing hardware to perform operations. The operations include receiving sensor data for a space within an environment about the robot. The operations further include receiving, from a user interface (UI) in communication with the data processing hardware, a user input indicating a user-selection of a location within a two-dimensional (2D) representation of the space. The location corresponds to a position of a target object within the space. The operations also include receiving, from the UI, a plurality of grasping inputs designating an orientation and a translation for an end-effector of a robotic manipulator to grasp the target object. Furthermore, the operations include generating, a three-dimensional (3D) location of the target object based on the received sensor data and the location corresponding to the user input. Additionally, the operations include instructing the end-effector of the robotic manipulator to grasp the target object using the generated 3D location and the plurality of grasping inputs designating the orientation and the translation of the end-effector of the robotic manipulator.

Aspects of the disclosure may include one or more of the following optional features. In some implementations, the operations further include grasping, by the end-effector of the robotic manipulator, the target object. In some embodiments, the plurality of grasping inputs corresponds to a plurality of constraints on one or more degrees of freedom for the end-effector of the robotic manipulator. In further embodiments, the one or more degrees of freedom include a pitch of the end-effector, a roll of the end-effector, a first translation in an x-direction, and a second translation in a y-direction. In even further embodiments, the one or more degrees of freedom further includes a third translation in a z-direction.

In some examples, receiving the plurality of grasping inputs designating the orientation and the translation for the end-effector of the robotic manipulator to grasp the target object includes receiving a first grasping input designating a first orientation for the end-effector of the robotic manipulator to grasp the target object, and instructing modification of a viewport image including the target object at the UI based on the designed first orientation for the end-effector of the robotic manipulator. In further examples, the first orientation includes one of a pitch or a roll for the end-effector of the robotic manipulator to grasp the target object. In other further examples, the UI includes a first window and a second window separate from the first window. The first window includes the viewport image displaying the sensor data for the space within the environment about the robot that includes the target object. The second window includes a graphical icon representing the end-effector. The graphical icon is capable of being user-manipulated to indicate the first grasping input designating the first orientation for the end-effector of the robotic manipulator to grasp the target object. In even further examples, the graphical icon includes a wire-frame representation of the end-effector and a radial dial to designate a pitch as the first orientation for the end-effector of the robotic manipulator to grasp the target object. In other even further examples, the operations further include overlaying, on the viewport image, a representation of the end-effector at the first orientation designated by the first grasping input, and receiving, from the UI, a second grasping input designating a second orientation for the end-effector of the robotic manipulator to grasp the target object.

In additional even further examples, the second orientation corresponds to a roll for the end-effector of the robotic manipulator to grasp the target object. In other additional even further examples, receiving the second grasping input designating the second orientation includes receiving another user input indicating another user-selection of the graphical icon indicating the roll for the end-effector of the robotic manipulator to grasp the target object.

Another aspect of the disclosure provides a robot. The robot includes a body, a robotic manipulator coupled to the body, data processing hardware in communication with the robotic manipulator, and memory hardware in communication with the data processing hardware. The robotic manipulator includes an end-effector configured to grasp objects within an environment about the robot. The memory hardware stores instructions that, when executed on the data processing hardware, cause the data processing hardware to perform operations. The operations include receiving sensor data for a space within an environment about the robot. The operations further include receiving, from a user interface (UI) in communication with the data processing hardware, a user input indicating a user-selection of a location within a two-dimensional (2D) representation of the space. The location corresponds to a position of a target object within the space. The operations also include receiving, from the UI, a plurality of grasping inputs designating an orientation and a translation for the end-effector of the robotic manipulator to grasp the target object. Furthermore, the operations include generating a three-dimensional (3D) location of the target object based on the received sensor data and the location corresponding to the user input. Additionally, the operations include instructing the end-effector of the robotic manipulator to grasp the target object using the generated 3D location and the plurality of grasping inputs designating the orientation and the translation of the end-effector of the robotic manipulator.

Aspects of the disclosure may include one or more of the following optional features. In some implementations, the operations further include grasping, by the end-effector of the robotic manipulator, the target object. In some embodiments, the plurality of grasping inputs corresponds to a plurality of constraints on one or more degrees of freedom for the end-effector of the robotic manipulator. In further embodiments, the one or more degrees of freedom include a pitch of the end-effector, a roll of the end-effector, a first translation in an x-direction, and a second translation in a y-direction. In even further embodiments, the one or more degrees of freedom further includes a third translation in a z-direction.

In some examples, receiving the plurality of grasping inputs designating the orientation and the translation for the end-effector of the robotic manipulator to grasp the target object includes receiving a first grasping input designating a first orientation for the end-effector of the robotic manipulator to grasp the target object, and instructing modification of a viewport image including the target object at the UI based on the designed first orientation for the end-effector of the robotic manipulator. In further examples, the first orientation includes one of a pitch or a roll for the end-effector of the robotic manipulator to grasp the target object. In other further examples, the UI includes a first window and a second window separate from the first window. The first window includes the viewport image displaying the sensor data for the space within the environment about the robot that includes the target object, the second window includes a graphical icon representing the end-effector. The graphical icon is capable of being user-manipulated to indicate the first grasping input designating the first orientation for the end-effector of the robotic manipulator to grasp the target object. In even further examples, the graphical icon comprises a wire-frame representation of the end-effector and a radial dial to designate a pitch as the first orientation for the end-effector of the robotic manipulator to grasp the target object. In other even further examples, the operations further include overlaying, on the viewport image, a representation of the end-effector at the first orientation designated by the first grasping input and receiving, from the UI, a second grasping input designating a second orientation for the end-effector of the robotic manipulator to grasp the target object.

In additional even further examples, the second orientation corresponds to a roll for the end-effector of the robotic manipulator to grasp the target object. In other additional even further examples, receiving the second grasping input designating the second orientation includes receiving another user input indicating another user-selection of the graphical icon indicating the roll for the end-effector of the robotic manipulator to grasp the target object.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a perspective view of an example robot capable of grasping an object.

FIG. 1B is a perspective view of the robot of FIG. 1A with a remote controller in communication with the robot.

FIG. 1C is a schematic view of example systems of the robot of FIG. 1A.

FIGS. 2A-2C are schematic views of example grasping systems for the robot of FIG. 1A.

FIG. 3A is a schematic view of an example environment of a user interface for grasping an object using the robot of FIG. 1A.

FIGS. 3B-3F are schematic views of example user interfaces for coordinating with the robot of FIG. 1A to grasp an object.

FIG. 4 is a flowchart of an example arrangement of operations for a method of supervised autonomous grasping.

FIG. 5 is a flowchart of an example arrangement of operations for a method of using a user interface for supervised autonomous grasping.

FIG. 6 is a schematic view of an example computing device that may be used to implement the systems and methods described herein.

Like reference symbols in the various drawings indicate like elements.

### DETAILED DESCRIPTION

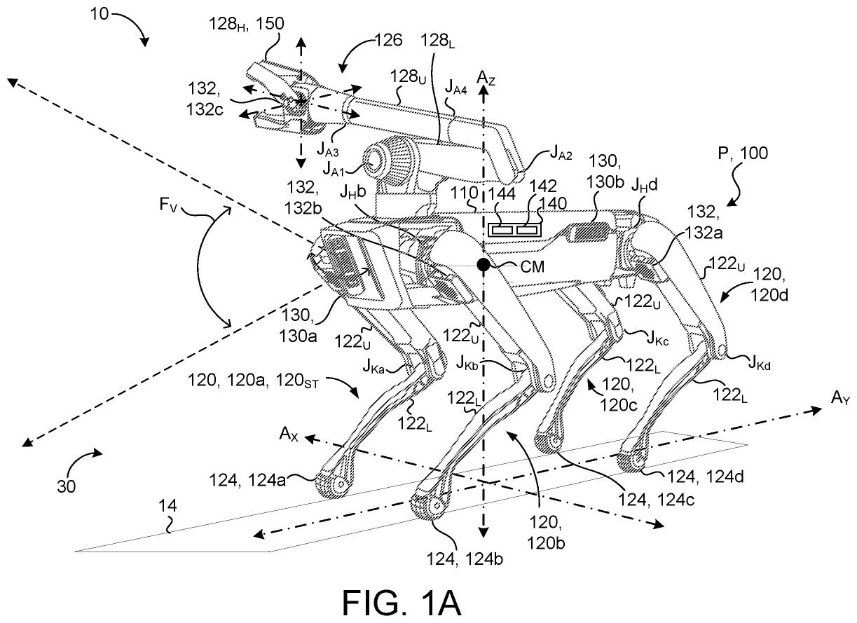

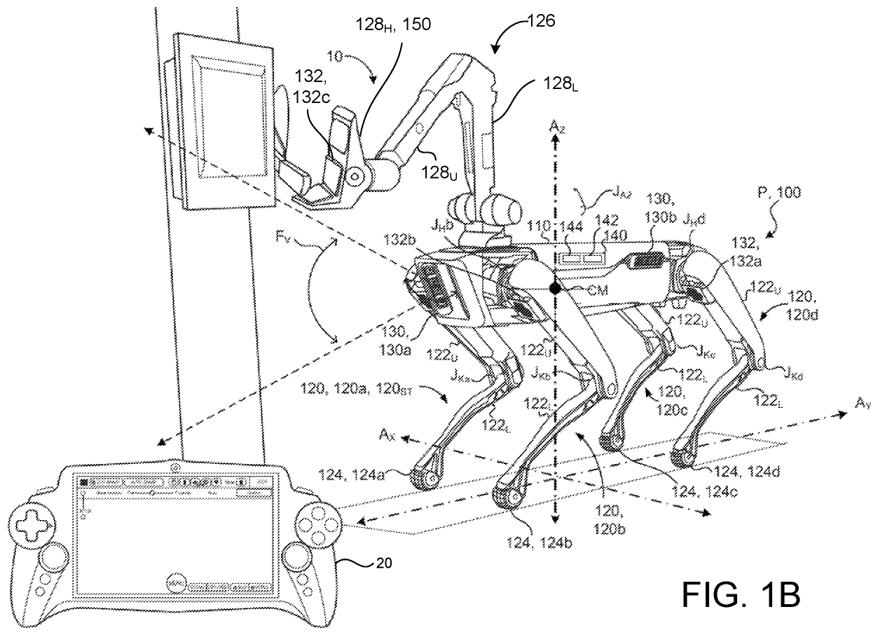

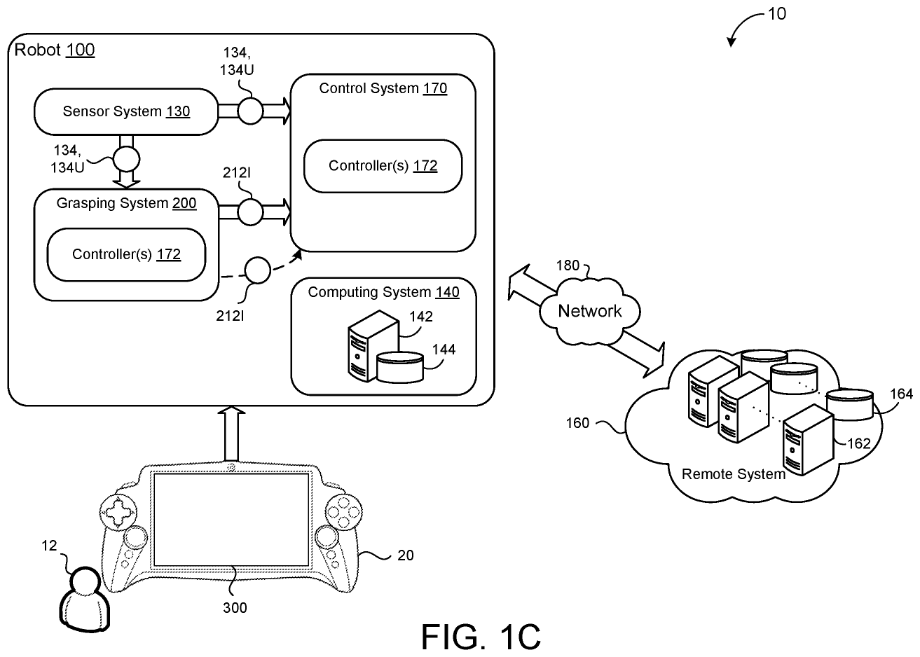

Referring to FIGS. 1A-1C, the robot 100 includes a body 110 with locomotion based structures such as legs 120a-d coupled to the body 110 that enable the robot 100 to move about the environment 10. In some examples, each leg 120 is an articulable structure such that one or more joints J permit members 122 of the leg 120 to move. For instance, each leg 120 includes a hip joint JH coupling an upper member 122, 122_{U} of the leg 120 to the body 110 and a knee joint JK coupling the upper member 122_{U} of the leg 120 to a lower member 122_{L} of the leg 120. Although FIG. 1A depicts a quadruped robot with four legs 120a-d, the robot 100 may include any number of legs or locomotive based structures (e.g., a biped or humanoid robot with two legs, or other arrangements of one or more legs) that provide a means to traverse the terrain within the environment 10.

In order to traverse the terrain, each leg 120 has a distal end 124 that contacts a surface of the terrain (i.e., a traction surface). In other words, the distal end 124 of the leg 120 is the end of the leg 120 used by the robot 100 to pivot, plant, or generally provide traction during movement of the robot 100. For example, the distal end 124 of a leg 120 corresponds to a foot of the robot 100. In some examples, though not shown, the distal end 124 of the leg 120 includes an ankle joint JA such that the distal end 124 is articulable with respect to the lower member 122_{L} of the leg 120.

In the examples shown, the robot 100 includes an arm 126 that functions as a robotic manipulator. The arm 126 may be configured to move about multiple degrees of freedom in order to engage elements of the environment 10 (e.g., objects within the environment 10). In some examples, the arm 126 includes one or more members 128, where the members 128 are coupled by joints J such that the arm 126 may pivot or rotate about the joint(s) J. For instance, with more than one member 128, the arm 126 may be configured to extend or to retract. To illustrate an example, FIG. 1A depicts the arm 126 with three members 128 corresponding to a lower member 128_{L}, an upper member 128_{U}, and a hand member 128_{H} (e.g., shown as an end-effector 150). Here, the lower member 128_{L} may rotate or pivot about a first arm joint J_{A1} located adjacent to the body 110 (e.g., where the arm 126 connects to the body 110 of the robot 100). The lower member 128_{L} is coupled to the upper member 128_{U} at a second arm joint J_{A2} and the upper member 128_{U} is coupled to the hand member 128_{H} at a third arm joint J_{A3}. In some examples, such as FIGS. 1A and 1B, the hand member 128_{H} or end-effector 150 is a mechanical gripper that includes a moveable jaw and a fixed jaw configured to perform different types of grasping of elements within the environment 10. The moveable jaw is configured to move relative to the fixed jaw in order to move between an open position for the gripper and a closed position for the gripper (e.g., closed around an object). In some implementations, the arm 126 additionally includes a fourth joint J_{A4}. The fourth joint J_{A4} may be located near the coupling of the lower member 128_{L} to the upper member 128_{U} and function to allow the upper member 128_{U} to twist or rotate relative to the lower member 128_{L}. In other words, the fourth joint J_{A4} may function as a twist joint similarly to the third joint J_{A3} or wrist joint of the arm 126 adjacent the hand member 128_{H}. For instance, as a twist joint, one member coupled at the joint J may move or rotate relative to another member coupled at the joint J (e.g., a first member coupled at the twist joint is fixed while the second member coupled at the twist joint rotates). In some implementations, the arm 126 connects to the robot 100 at a socket on the body 110 of the robot 100. In some configurations, the socket is configured as a connector such that the arm 126 may attach or detach from the robot 100 depending on whether the arm 126 is needed for operation.

The robot 100 has a vertical gravitational axis (e.g., shown as a Z-direction axis Az) along a direction of gravity, and a center of mass CM, which is a position that corresponds to an average position of all parts of the robot 100 where the parts are weighted according to their masses (i.e., a point where the weighted relative position of the distributed mass of the robot 100 sums to zero). The robot 100 further has a pose P based on the CM relative to the vertical gravitational axis Az (i.e., the fixed reference frame with respect to gravity) to define a particular attitude or stance assumed by the robot 100. The attitude of the robot 100 can be defined by an orientation or an angular position of the robot 100 in space. Movement by the legs 120 relative to the body 110 alters the pose P of the robot 100 (i.e., the combination of the position of the CM of the robot and the attitude or orientation of the robot 100). Here, a height generally refers to a distance along the z-direction (e.g., along a z-direction axis Az). The sagittal plane of the robot 100 corresponds to the Y-Z plane extending in directions of a y-direction axis AY and the z-direction axis Az. In other words, the sagittal plane bisects the robot 100 into a left and a right side. Generally perpendicular to the sagittal plane, a ground plane (also referred to as a transverse plane) spans the X-Y plane by extending in directions of the x-direction axis Ax and the y-direction axis AY. The ground plane refers to a ground surface 14 where distal ends 124 of the legs 120 of the robot 100 may generate traction to help the robot 100 move about the environment 30. Another anatomical plane of the robot 100 is the frontal plane that extends across the body 110 of the robot 100 (e.g., from a left side of the robot 100 with a first leg 120a to a right side of the robot 100 with a second leg 120b). The frontal plane spans the X-Z plane by extending in directions of the x-direction axis Ax and the z-direction axis Az.

In order to maneuver about the environment 10 or to perform tasks using the arm 126, the robot 100 includes a sensor system 130 with one or more sensors 132, 132a-n (e.g., shown as a first sensor 132, 132a and a second sensor 132, 132b). The sensors 132 may include vision/image sensors, inertial sensors (e.g., an inertial measurement unit (IMU)), force sensors, and/or kinematic sensors. Some examples of sensors 132 include a camera such as a stereo camera, a time-of-flight (TOF) sensor, a scanning light-detection and ranging (LIDAR) sensor, or a scanning laser-detection and ranging (LADAR) sensor. In some examples, the sensor 132 has a corresponding field(s) of view Fv defining a sensing range or region corresponding to the sensor 132. For instance, FIG. 1A depicts a field of a view Fv for the robot 100. Each sensor 132 may be pivotable and/or rotatable such that the sensor 132 may, for example, change the field of view Fv about one or more axis (e.g., an x-axis, a y-axis, or a z-axis in relation to a ground plane).

When surveying a field of view Fv with a sensor 132, the sensor system 130 generates sensor data 134 (also referred to as image data) corresponding to the field of view Fv. The sensor system 130 may generate the field of view Fv with a sensor 132 mounted on or near the body 110 of the robot 100 (e.g., sensor(s) 132a, 132b). The sensor system may additionally and/or alternatively generate the field of view Fv with a sensor 132 mounted at or near the end-effector 150 of the arm 126 (e.g., sensor(s) 132c). The one or more sensors 132 may capture sensor data 134 that defines the three-dimensional point cloud for the area within the environment 10 about the robot 100. In some examples, the sensor data 134 is image data that corresponds to a three-dimensional volumetric point cloud generated by a three-dimensional volumetric image sensor 132. Additionally or alternatively, when the robot 100 is maneuvering about the environment 10, the sensor system 130 gathers pose data for the robot 100 that includes inertial measurement data (e.g., measured by an IMU). In some examples, the pose data includes kinematic data and/or orientation data about the robot 100, for instance, kinematic data and/or orientation data about joints J or other portions of a leg 120 or arm 126 of the robot 100. With the sensor data 134, various systems of the robot 100 may use the sensor data 134 to define a current state of the robot 100 (e.g., of the kinematics of the robot 100) and/or a current state of the environment 30 about the robot 100.

In some implementations, the sensor system 130 includes sensor(s) 132 coupled to a joint J. Moreover, these sensors 132 may couple to a motor M that operates a joint J of the robot 100 (e.g., sensors 132, 132a-b). Here, these sensors 132 generate joint dynamics in the form of joint-based sensor data 134. Joint dynamics collected as joint-based sensor data 134 may include joint angles (e.g., an upper member 122_{U} relative to a lower member 122_{L} or hand member 126_{H} relative to another member of the arm 126 or robot 100), joint speed (e.g., joint angular velocity or joint angular acceleration), and/or forces experienced at a joint J (also referred to as joint forces). Joint-based sensor data generated by one or more sensors 132 may be raw sensor data, data that is further processed to form different types of joint dynamics, or some combination of both. For instance, a sensor 132 measures joint position (or a position of member(s) 122 coupled at a joint J) and systems of the robot 100 perform further processing to derive velocity and/or acceleration from the positional data. In other examples, a sensor 132 is configured to measure velocity and/or acceleration directly.

As the sensor system 130 gathers sensor data 134, a computing system 140 stores, processes, and/or to communicates the sensor data 134 to various systems of the robot 100 (e.g., the control system 170, grasping system 200, and/or remote controller 20). In order to perform computing tasks related to the sensor data 134, the computing system 140 of the robot 100 includes data processing hardware 142 and memory hardware 144. The data processing hardware 142 is configured to execute instructions stored in the memory hardware 144 to perform computing tasks related to activities (e.g., movement and/or movement based activities) for the robot 100. Generally speaking, the computing system 140 refers to one or more locations of data processing hardware 142 and/or memory hardware 144.

In some examples, the computing system 140 is a local system located on the robot 100. When located on the robot 100, the computing system 140 may be centralized (i.e., in a single location/area on the robot 100, for example, the body 110 of the robot 100), decentralized (i.e., located at various locations about the robot 100), or a hybrid combination of both (e.g., where a majority of centralized hardware and a minority of decentralized hardware). To illustrate some differences, a decentralized computing system 140 may allow processing to occur at an activity location (e.g., at motor that moves a joint of a leg 120) while a centralized computing system 140 may allow for a central processing hub that communicates to systems located at various positions on the robot 100 (e.g., communicate to the motor that moves the joint of the leg 120).

Additionally or alternatively, the computing system 140 includes computing resources that are located remotely from the robot 100. For instance, the computing system 140 communicates via a network 180 with a remote system 160 (e.g., a remote server or a cloud-based environment). Much like the computing system 140, the remote system 160 includes remote computing resources, such as remote data processing hardware 162 and remote memory hardware 164. Here, sensor data 134 or other processed data (e.g., data processing locally by the computing system 140) may be stored in the remote system 160 and may be accessible to the computing system 140. In additional examples, the computing system 140 is configured to utilize the remote resources 162, 164 as extensions of the computing resources 142, 144 such that resources of the computing system 140 may reside on resources of the remote system 160.

In some implementations, as shown in FIGS. 1A and 1B, the robot 100 includes a control system 170. The control system 170 may be configured to communicate with systems of the robot 100, such as the at least one sensor system 130. The control system 170 may perform operations and other functions using hardware 140. The control system 170 includes at least one controller 172 that is configured to control the robot 100. For example, the controller 172 controls movement of the robot 100 to traverse about the environment 10 based on input or feedback from the systems of the robot 100 (e.g., the sensor system 130, the control system 170, and/or the grasping system 200). In additional examples, the controller 172 controls movement between poses and/or behaviors of the robot 100. At least one the controller 172 may be responsible for controlling movement of the arm 126 of the robot 100 in order for the arm 126 to perform various tasks using the end-effector 150. For instance, at least one controller 172 controls the end-effector 150 (e.g., gripper) to manipulate an object or element in the environment 10. For example, the controller 172 actuates the movable jaw in a direction towards the fixed jaw to close the gripper. In other examples, the controller 172 actuates the movable jaw in a direction away from the fixed jaw to open the gripper.

A given controller 172 may control the robot 100 by controlling movement about one or more joints J of the robot 100. In some configurations, the given controller 172 is software with programming logic that controls at least one joint J or a motor M which operates, or is coupled to, a joint J. For instance, the controller 172 controls an amount of force that is applied to a joint J (e.g., torque at a joint J). As programmable controllers 172, the number of joints J that a controller 172 controls is scalable and/or customizable for a particular control purpose. A controller 172 may control a single joint J (e.g., control a torque at a single joint J), multiple joints J, or actuation of one or more members 128 (e.g., actuation of the hand member 128_{H}) of the robot 100. By controlling one or more joints J, actuators or motors M, the controller 172 may coordinate movement for all different parts of the robot 100 (e.g., the body 110, one or more legs 120, the arm 126). For example, to perform some movements or tasks, a controller 172 may be configured to control movement of multiple parts of the robot 100 such as, for example, two legs 120a-b, four legs 120a-d, or two legs 120a-b combined with the arm 126.

Referring now to FIG. 1B, the sensor system 130 of the robot 100 generates a three-dimensional point cloud of sensor data 134 for an area or space or volume within the environment 10 about the robot 100. Although referred to as a three-dimensional point cloud of sensor data 134, it should be understood that the sensor data 134 may represent a three-dimensional portion of the environment 10 or a two-dimensional portion (such as a surface or plane) of the environment 10. In other words, the sensor data 134 may be a three-dimensional point cloud or a two-dimensional collection of points. The sensor data 134 corresponds to the current field of view Fv of the one or more sensors 132 mounted on the robot 100. In some examples, the sensor system 130 generates the field of view Fv with the one or more sensors 132c mounted at or near the end-effector 150. In other examples, the sensor system 130 additionally and/or alternatively generates the field of view Fv based on the one or more sensors 132a, 132b mounted at or near the body 110 of the robot 100. The sensor data 134 updates as the robot 100 maneuvers within the environment 10 and the one or more sensors 132 are subject to different field of views Fv. The sensor system 130 sends the sensor data 134 to the control system 170, grasping system 200, and/or remote controller 20.

A user 12 may interact with the robot 100 via the remote controller 20 that communicates with the robot 100 to perform actions. Additionally, the robot 100 may communicate with the remote controller 20 to display an image on a user interface 300 (e.g., UI 300) of the remote controller 20. The UI 300 is configured to display the image that corresponds to three-dimensional field of view Fv of the one or more sensors 132 or to toggle between sensors 132 in order to display different images corresponding to a respective field of views Fv for a given sensor 132. The image displayed on the UI 300 of the remote controller 20 is a two-dimensional image that corresponds to the three-dimensional point cloud of sensor data 134 (e.g., field of view Fv) for the area within the environment 10 about the robot 100. That is, the image displayed on the UI 300 is a two-dimensional image representation that corresponds to the three-dimensional field of view Fv of the one or more sensors 132.

The image displayed on the UI 300 may include one or more objects that are present in the environment 10 (e.g., within a field of view Fv for a sensor 132 of the robot 100). In some examples, the grasping system 200 or some other system of the robot 100 may be configured to classify an image in order to identify one or more objects within the image (e.g., to identify one or more graspable objects). In some implementations, the image is classified by a machine learning algorithm in order to identify the presence of one or more graspable objects in the image that correspond to one or more graspable objects within a portion of the environment 10 corresponding to the image. In particular, the sensor system 130 receives the image that corresponds to the area (e.g., environment 10) and sends the image (e.g., sensor data 134) to the grasping system 200. The grasping system 200 classifies graspable objects within the received image (e.g., sensor data 134) using a machine learning object classification algorithm. For example, the grasping system 200 may classify a piece of clothing on the ground as “laundry,” or a piece of trash on the ground as “trash.” The classification of the objects in the image may display to the user 12 on the UI 300. The UI 300 may further calibrate the received image to display for the user 12. The UI 300 allows the user 12 to select an object displayed in the two-dimensional image as a target object in order to instruct the robot 100 to perform an action upon the selected target object in the three-dimensional environment 10.

In some implementations, the target object selected by the user corresponds to a respective object for an end-effector 150 of a robotic manipulator of the robot 100 to grasp. For example, the sensor system 130 of a robot 100 in a manufacturing environment 10 generates a three-dimensional point cloud of sensor data 134 for an area within the manufacturing environment 10. The UI 300 displays the two-dimensional image that corresponds to the three-dimensional point cloud of sensor data 134 within the manufacturing environment 10. The user 12 may instruct the robot 100 to grasp a target object (e.g., a valve) within the manufacturing environment 10 by selecting the target object (e.g., valve) on the UI 300. The remote controller 20 sends the selected target object to the robot 100 to execute the grasp on the target object.

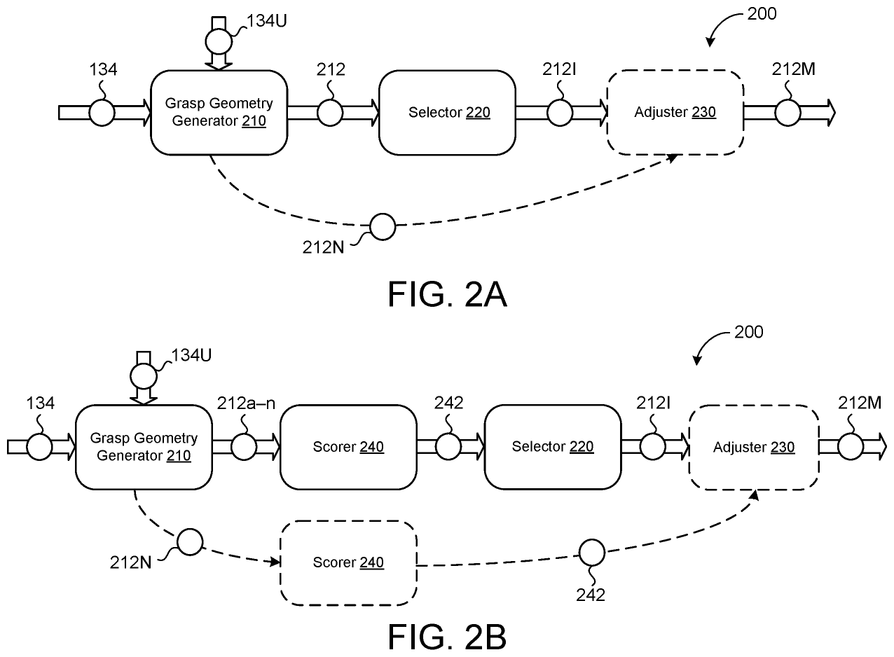

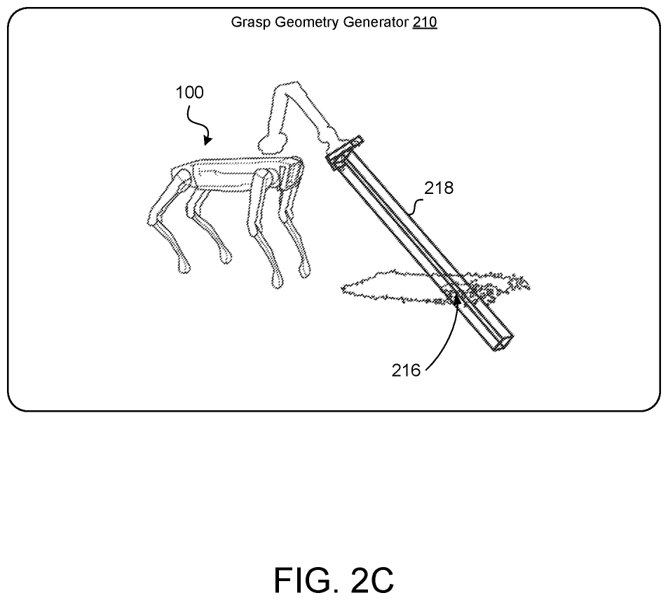

The grasping system 200 receives the user-selected target object and sensor data 134. From the user-selected target object and sensor data 134, the grasping system 200 identifies an area within the three-dimensional environment 10 where the target object is located. For instance, the grasping system 200 generates a grasp area corresponding to the area within the three-dimensional environment 10 where the target object is actually located in to order designate where the end-effector 150 is to grasp the target object. In particular, the grasping system 200 transforms the user-selected target object from the two-dimensional image to the grasp area on the three-dimensional point cloud of sensor data 134. By generating the grasp area, the grasping system 200 allows the selected target object from the two-dimensional image to instruct the robot 100 to grasp the target object in the three-dimensional environment 10. In some configurations, the grasping system 200 generates the grasp area by projecting a plurality of rays from the selected target object of the image onto the three-dimensional point cloud of sensor data 134, as discussed in more detail below in FIG. 2C. After determining the grasp area, the grasping system 200 determines a grasp geometry 212 for the robotic manipulator (i.e., the arm 126 of the robot 100) to grasp the target object with. The grasp geometry 212 indicates the pose of the end-effector 150 of the robotic manipulator, where the pose represents the translation (e.g., x-coordinate, y-coordinate, and z-coordinate) and orientation (e.g., pitch, yaw, and roll) of the end-effector 150. That is, the grasp geometry 212 indicates the pose (e.g., orientation and translation) that the end-effector 150 of the robotic manipulator uses to grasp the target object.

The grasping system 200 sends an initial grasp geometry 212I to one or more controllers 172 that instruct the robot 100 to execute the grasp geometry 212 on the target object. In some implementations, the grasping system 200 includes one or more dedicated controllers 172 to instruct the robot 100 to execute the grasp geometry 212. In other implementations, the grasping system 200 sends the grasp geometry 212 to one or more controllers 172 of the control system 170 that instruct the robot 100 to execute the grasp geometry 212.

Referring now to FIG. 2A, in some implementations, the grasping system 200 determines the grasp geometry 212 for the end-effector 150 of the robotic manipulator to grasp the targeted object selected by the user 12. That is, the grasping system 200 determines the pose (e.g., orientation and translation) of the end-effector 150 of the robotic manipulator to grasp the target object. The grasping system 200 may include a grasp geometry generator 210 and a selector 220 to determine the grasp geometry 212. The grasp geometry generator 210 receives sensor data 134 from the sensor system 130. The grasp geometry generator 210 is configured to generate the grasp geometry 212 for the end-effector 150 of the robotic manipulator to grasp the selected target object based on the grasp area and sensor data 134. In particular, the grasp geometry generator 210 receives the selected target object and the sensor data 134 to generate the grasp area. Based on the grasp area, the grasp geometry generator 210 determines the grasp geometry 212 (e.g., orientation and translation) of the end-effector 150 to grasp the target object. The grasp geometry generator 210 sends the grasp geometry 212 to the selector 220. The selector 220 is configured to implement the grasp geometry 212 received from the grasp geometry generator 210. In particular, the selector 220 sends the initial grasp geometry 212I to the control system 170. The control system 170 instructs the robot 100 to begin execution of the initial grasp geometry 212I to grasp the selected target object.

In some implementations, the user 12 may input an end-effector constraint at the remote controller 20 where the end-effector constraint constrains one or more degrees of freedom of the end-effector 150. The degrees of freedom may include translation (e.g., x-coordinate, y-coordinate, and z-coordinate) and/or orientation (e.g., pitch, roll, and yaw) of the end-effector 150. In other words, the end-effector 150 may have six degrees of freedom where three of the degrees relate to translation and three relate to orientation. The user 12 may instruct the end-effector 150 to grasp the target object with a grasp geometry 212 that includes the end-effector constraint in order to constrain a degree of freedom for the end-effector 150. For example, the user 12 may instruct the robot 100 to grasp the target object with a pitch of ninety degrees. In this example, the grasping system 200 can generate any grasp geometry that includes a pitch of ninety degrees. In another example, the user 12 instructs the robot 100 to grasp the target object with a grasp geometry 212 that includes a specific height (e.g., z-coordinate). Thus, the grasp geometry generator 210 can generate a grasp geometry 212 that includes the user-selected z-coordinate. The user 12 may include any number of end-effector constraints to constrain the end-effector 150 when grasping the target object. For instance, combining both examples, the user 12 may input end-effector 150 constraints for both pitch and the z-coordinate (e.g., when assigning the target object for the end-effector 150 to grasp). The end-effector constraint allows the user 12 to customize any number of degrees of freedom for the end-effector 150 to grasp the target object.

In some implementations, after the robot 100 begins to execute the initial grasp geometry 212I, the grasping system 200 may determine a new grasp geometry 212N to grasp the target object. The grasping system 200 may determine, after the robot 100 begins execution of the initial grasp geometry 212I, a new grasp geometry 212N that improves and/or refines the grasp geometry 212 being executed. Here, an improvement or refinement in the grasp geometry 212 may correspond to a grasp geometry 212 that is more efficient (e.g., a more cost effective grasp in terms of energy or motion), has a higher likelihood of success, has a more optimal execution time (e.g., faster or slower), etc., to grasp the target object when compared to the initial grasp geometry 212I. The grasping system 200 may generate the new grasp geometry 212N based on updated sensor data 134U that represents the changing field of view Fv for one or more sensors 132 as the robot 100 maneuvers within the environment 30 to grasp the target object. That is, as the robot 100 maneuvers within the environment 30 to execute the initial grasp geometry 212I to grasp the target object, the one or more sensors 132 capture the changing the field of view Fv within the environment 10. Based on the changing field of view Fv (e.g., updated sensor data 134U) the grasping system determines the new grasp geometry 212N. For example, a sensor 132 of the robot 100 (e.g., a sensor 132 mounted on or near the end-effector 150) may generate sensor data 134 at some sensing frequency. Thus, while the robot 100 moves to execute the initial grasp geometry 212I, the sensor 132 may move and may generate new sensor data 134 (referred to as “updated sensor data 134U”) at the sensing frequency that inherently may include new information that is capable of improving or refining the initial grasp geometry 212I. The grasping system 200 may therefore leverage this updated sensor data 134U as the grasp by the end-effector 150 is being performed according to the initial grasp geometry 212I to update or to modify the initial grasp geometry 212I; thus leading to a continuous or periodic feedback loop that ensures that the target object is optimally grasped.

As an example, while the end-effector 150 of the robotic manipulator moves to execute the initial grasp geometry 212I, the sensor system 130 receives updated sensor data 134U that indicates a foreign object near the target object. In particular, as the end-effector 150 maneuvers within the environment 10, the sensor 132c has a field of view Fv within the environment 10 that is different than the field of view Fv before the robot 100 began execution of the initial grasp geometry 212I (i.e., an initial field of view Fv when the initial grasp geometry 212I was generated). In this example, the foreign object was outside the field of view Fv of the sensor system 130 before the robot 100 began execution of the initial grasp geometry 212I. Because the foreign object was outside the field of view Fv, the sensor system 130 did not represent the foreign object in the sensor data 134 sent to the grasp geometry generator 210. Thus, the grasp geometry generator 210 may generate an initial grasp geometry 212I that failed to account for the foreign object (e.g., an obstruction by the foreign object) because the sensor data 134 sent to the grasp geometry generator 210 did not indicate any foreign objects near the target object. Without any knowledge of the foreign object, if the robot 100 executed the initial grasp geometry 212I, the foreign object may prevent the end-effector 150 from successfully grasping the target object. In this example, the robot 100 may modify the initial grasp geometry 212I based on the updated sensor data 134U (e.g., the sensor data 134U that includes the foreign object) to successfully grasp the target object.

In some implementations, during the time period between when the end-effector 150 of the robotic manipulator starts executing the grasp geometry 212 and before completing the execution of the grasp geometry 212 on the target object, the sensor system 130 receives updated sensor data 134U. That is, while the end-effector 150 of the robotic manipulator moves to execute the initial grasp geometry 212I on the target object, the sensor system 130 receives updated sensor data 134U. The updated sensor data 134U represents the updated field of view Fv as the robot 100 moves within the environment 30 to grasp the target object. In particular, the updated sensor data 134U may provide additional information (e.g., a foreign object at or near the target object) to the grasping system 200 that was not available before the grasping system 200 determined the initial grasp geometry 212I. For example, the sensor system 130 of the robot 100 receives sensor data 134 that represents the current field of view Fv of the robot 100, after the robot 100 begins to execute the grasp geometry 212 the sensor system 130 of the robot 100 receives updated sensor data 134U as the robot 100 moves to execute the grasp. In some examples, the grasping system 200 may modify the grasp geometry 212 based on the updated sensor data 134U (e.g., the updated sensor data 134U indicates a foreign object that prevents the robot 100 from grasping the target object). In other examples, the grasping system 200 may continue to execute the initial grasp geometry 212I after receiving the updated sensor data 134U (e.g., the updated sensor data 134U indicates the same or substantially similar data as the initial sensor data 134). In this sense, the grasping system 200 may review the validity of the initial grasp geometry 212I using sensor data 134 provided to the grasping system 200 after the grasping system 200 generates the initial grasp geometry 212I. Upon review of the initial grasp geometry 212I based on the received updated sensor data 134U, the robot 100 may continue to execute the initial grasp geometry 212I (e.g., the initial grasp geometry 212I is still optimal when compared to other candidate grasp geometries 212 generated using the updated sensor data 134U), modify the initial grasp geometry 212I, or completely switch to an alternative grasp geometry 212.

Optionally, the grasping system 200 may include an adjuster 230. The adjuster 230 is indicated by dashed lines because the adjuster 230 is an optional component of the grasping system 200. The adjuster 230 is configured to determine whether to adjust the initial grasp geometry 212I after the end-effector 150 of the robotic manipulator begins to execute the initial grasp geometry 212I. As the robot 100 executes the initial grasp geometry 212I, the grasp geometry generator 210 receives updated sensor data 134U from the one or more sensors 132. Based on the updated sensor data 134U the grasp geometry generator 210 generates a new candidate grasp geometry 212N. The grasp geometry generator 210 sends the new candidate grasp geometry 212N to the adjuster 230. The adjuster 230 may also receive the initial grasp geometry 212I from the selector 220. The adjuster 230 determines whether to modify the initial grasp geometry 212I based on the new grasp geometry 212N and updated sensor data 134U. That is, after beginning execution of the initial grasp geometry 212I, the adjuster 230 receives the new candidate grasp geometry 212N and the updated sensor data 134U. In other words, the grasping system 200 generated the initial grasp geometry 212I using sensor data 134 at a first instance of time (e.g., when the user 12 selects the target object for the end-effector 150 to grasp) and then, the grasping system 200 generates one or more new candidate grasp geometries 212N using the updated sensor data 134U at a second instance of time subsequent to the first instance of time (e.g., when the robotic manipulator and/or end-effector 150 is executing a grasp of the target object). Based on the updated sensor data 134U, the adjuster 230 determines whether to continue execution of the initial grasp geometry 212I or modify the initial grasp geometry 212I.

In some examples, the adjuster 230 determines to continue execution of the initial grasp geometry 212I. In other examples, the adjuster 230 determines to modify the initial grasp geometry 212I to generate a modified grasp geometry 212M. That is, after receiving the updated sensor data 134U, the adjuster 230 compares the initial grasp geometry 212I and the new candidate grasp geometry 212N and determines that it should modify the initial grasp geometry 212I. For example, when the updated sensor data 134U indicates a foreign object at or near the target object, the adjuster 230 determines the new candidate grasp geometry 212N includes a higher likelihood of success to grasp the target object than the initial grasp geometry 212I. In another example, based on the updated sensor data 134U, the adjuster 230 determines the new candidate grasp geometry 212N includes a shorter grasp execution time than the initial grasp geometry 212I. The adjuster 230 may modify the initial grasp geometry 212I by adjusting one or more degrees of freedom to match or more closely match characteristics of the new candidate grasp geometry 212N. In some implementations, the adjuster 230 modifies the initial grasp geometry 212I by discarding the initial grasp geometry 212I and executing the new candidate grasp geometry 212N. After modifying the initial grasp geometry 212I, the adjuster 230 sends the modified grasp geometry 212M to the control system 170 to instruct the robot 100 to execute the modified grasp geometry 212M. When the adjuster 230 determines that the initial grasp geometry 212I should continue being executed, the adjuster 230 does not send the modified grasp geometry 212M to the control system 170.

Referring now to FIG. 2B, in some implementations, the grasp geometry generator 210 generates a plurality of candidate grasp geometries 212, 212a-n based on the selected target object within the grasp area. In particular, the grasp geometry generator 210 generates multiple candidate grasp geometries 212 and the grasping system 200 determines which of the multiple candidate grasp geometries 212 the robot 100 should use to grasp the target object. In these implementations, the grasping system 200 includes a scorer 240 that assigns a grasping score 242 to each of the plurality of candidate grasp geometries 212. The grasping score 242 indicates a likelihood of success that the candidate grasp geometry 212 will successfully grasp the target object. That is, based on the selected target object, sensor data 134, and the grasp area, the grasp geometry generator 210 generates a plurality of grasp geometries 212 to grasp the target object. Here, the grasp geometry generator 210 sends each of the plurality of candidate grasp geometries 212 to the scorer 240. For each candidate grasp geometry 212 of the plurality of candidate grasp geometries 212, the scorer 240 determines a grasping score 242 that represents the candidate grasp geometry's capability to grasp the target object. The scorer 240 sends each grasping score 242 that corresponds to the respective candidate grasp geometry 212 of the plurality of candidate grasp geometries 212 to the selector 220. The generator 210 may generate a plurality of grasp geometries 212 because there are a number of pose permutations possible that enable the end-effector 150 to grasp some portion of the target object. For instance, the end-effector 150 may approach and/or grasp the target object from a particular direction or movement vector in 3D space or at a particular orientation (e.g., pitch, roll, or yaw). In other words, since the end-effector 150 may have multiple degrees of freedom at its disposal to affect the manner in which the end-effector 150 grasps the target object, the generator 210 may generate some number of these permutations as candidate grasp geometries 212.

In some configurations, there may be such a large number of potential candidate grasp geometries 212 that the generator 210 may work in conjunction with the selector 220 to generate an N-best number of grasp geometries 212 at a particular instance of time. In some implementations, the generator 210 is preconfigured to generate a maximum number of candidate grasp geometries 212 at any particular instant in time. In some examples, the number of grasp geometries 212 may be reduced, discounted, or decayed based on the relative timing of when the generator 210 generates the grasp geometries 212. For example, the generator 210 may generate a large number of grasp geometries 212 to form the initial grasp geometry 212I at a first instance of time, but then, at a second instance of time, the generator 210 may be configured to generate a smaller number of grasp geometries 212 while the robotic manipulator is executing the initial grasp geometry 212I.

The selector 220 is configured to select the respective candidate grasp geometry 212 with a greatest grasping score 242 as a grasp geometry 212 for the robot 100 to use to grasp the target object. The grasping score 242 may be generated by a scoring algorithm that accounts for different factors that identify an overall performance for a given grasping geometry 212. These factors may be preconfigured or designed by the user 12 of the robot 100. Some examples of factors that may contribute to the grasping score 242 include a speed to grasp the target object (e.g., a time to grasp the object), a degree of complication for the particular grasp, the degree of change from the current pose of the end-effector 150 to the grasping pose of the end-effector 150, the engagement of the grasp geometry 212 with the target object (e.g., engagement location relative to the centroid of the target object), the amount of torque the target object may be estimated to contribute, the amount of force or direction of force that the end-effector 150 imparts on the target object, etc. When determining the grasping score 242, the factors that influence the score 242 may also be weighted to stress an importance of one factor over another factor. For instance, if the target object has been classified as a fragile object, the scoring algorithm may discount the speed of the grasp to ensure the fragile object is less likely to be damaged. Based on some number of these factors, the grasping score 242 may generally indicate an efficiency, execution time, likelihood of success, etc. of a grasp geometry. In some examples, the selector 220 selects the candidate grasp geometry 212 from the plurality of candidate grasp geometries 212 when the grasping score 242 satisfies a grasping score threshold (e.g., when the grasping score 242 exceeds a value set as the grasping score threshold). As an example, the selector 220 receives three candidate grasp geometries 212 that include grasping scores 242 of 0.6, 0.4, and 0.8. In this example, the selector 220 determines the candidate grasp geometry 212 with the grasping score 0.8 has the highest likelihood to successfully grasp the target object. The selector 220 sends the selected candidate grasp geometry 212 (e.g., initial grasp geometry 212I) from the plurality of candidate grasp geometries 212 to the control system 170. The control system 170 instructs the robot 100 to execute the candidate grasp geometry 212 with the grasping score 242 of 0.8 as initial grasp geometry 212I.

The grasping system 200 sends the initial grasp geometry 212I to the control system 170 to initiate a sequence of movements to grasp the target object according to the initial grasp geometry 212I. In other words, to execute the initial grasp geometry 212I, the control system 170 instructs the arm 126 to move from an initial pose of the arm 126 to a grasping pose designated by the initial grasping geometry 212I. Here, the initial pose of the arm 126 refers to the pose or state of the arm 126 when the controller 20 received the input from the user 12 selecting the target object to be grasped by the end-effector 150 of the arm 126. In this respect, the initial grasp geometry 212I may be based on the initial pose for the end-effector 150 of the robotic manipulator. For instance, when the sensor 132 providing the image to the user 12 at the controller 20 is from a sensor 132 at the end-effector 150, the field of view Fv of the sensor 132 associated with the end-effector 150 would be used to define the initial grasp geometry 212I and that field of view Fv is based on the initial pose of the arm 126.

In some implementations, the grasping system 200 determines a plurality of new candidate grasp geometries 212N after the robot 100 begins execution on the initial grasp geometry 212I. That is, while the end-effector 150 of the robotic manipulator moves to grasp the target object based on the initial grasp geometry 212I the sensor system 130 receives updated sensor data 134U for a second pose of the end-effector 150 of the robotic manipulator. The sensor system 130 sends the updated sensor data 134U to the grasping system 200. The grasp geometry generator 210 determines a new set of candidate grasp geometries 212N based on the updated sensor data 134. The new set of candidate grasp geometries 212N may include any number of new candidate grasp geometries 212N. The grasp geometry generator 210 sends each new candidate grasp geometry 212N to the scorer 240.

The scorer 240 that scores the new candidate grasp geometry 212N may be the same scorer 240 used to score the candidate grasp geometries 212 that resulted in the initial grasp geometry 212I or a different scorer 240 dedicated to scoring new candidate grasp geometries 212N. In either case, the scorer 240 assigns a grasping score 242 to each new candidate grasp geometry 212N of the new set of candidate grasp geometries 212N. That is, the grasp geometry generator 210 sends the plurality of new candidate grasp geometries 212N to the scorer 240 that determines the grasping score 242 for each of the plurality of new candidate grasp geometries 212N. The scorer 240 sends the grasping score 242 for each respective new candidate grasp geometry 212N to the adjuster 230. In some examples, the scorer 240 sends only the highest grasping score 242 from the plurality of new candidate grasp geometries 212N. The adjuster 230 determines whether a respective grasp geometry 212 from the new set of candidate grasp geometries 212N includes a corresponding grasping score 242 that exceeds the grasping score 242 of the initial grasp geometry 212I (i.e., a score 242 that indicates a candidate grasp geometry 212N is better than the initial grasp geometry 212I). That is, the adjuster 230 receives the updated sensor data 134U and the respective grasping score 242 for the initial grasp geometry 212I and for each new candidate grasp geometry 212N.

In some implementations, when the corresponding grasping score 242 of the new candidate grasp geometries 212N exceeds the grasping score 242 of the initial grasp geometry 212I, the adjuster 230 modifies the initial grasp geometry 212I based on the respective candidate grasp geometry 212N from the new set of candidate grasp geometries 212N. For example, the robot 100 begins execution of the initial grasp geometry 212I with a grasping score of 0.8. After the robot 100 begins execution of the initial grasp geometry 212I, the grasp geometry generator 210 receives updated sensor data 134U that corresponds to the current field of view Fv of the one or more sensors 132. The grasp geometry generator 210 generates a plurality of new candidate grasp geometries 212N based on the updated sensor data 134. In this example, the adjuster 230 receives the initial grasp geometry 212I with the grasping score 242 of 0.8 and receives a new candidate grasp geometry 212N with a grasping score 242 of 0.85. Here, the adjuster 230 determines the grasping score 242 (e.g., grasping score 242 of 0.85) for the new candidate grasp geometry 212N exceeds the grasping score 242 (e.g., grasping score 242 of 0.8) of the initial grasp geometry 212I and modifies the initial grasp geometry 212I. As state previously, this modification may some form of adjustment to the initial grasp geometry 212I or complete replacement of the initial grasp geometry 212I with the new candidate grasp geometry 212N.

In some implementations, the adjuster 230 only modifies the initial grasp geometry 212I when the grasping score 242 of the new candidate grasp geometry 212N exceeds the score 242 of the initial grasp geometry 212I by a threshold. For example, the adjuster 230 only modifies the initial grasp geometry 212I when the grasping score 242 of the new candidate grasp geometry 212N exceeds the grasping score 242 of the initial grasp geometry 212I by a margin of 0.1. In this example, when the grasping score 242 of the initial grasp geometry 212I is 0.6 and the grasping score 242 of the new candidate grasp geometry 212N is 0.65, the adjuster 230 determines the grasping score 242 of the new candidate grasp geometry 212N does not exceed the grasping score 242 of the initial grasp geometry 212I by the threshold (e.g., 0.1). Here, even though the grasping score 242 of the new candidate grasp geometry 212N exceeds the grasping score 242 of the initial grasp geometry 212I, the robot 100 continues execution of the initial grasp geometry 212I. Stated differently, the margin of difference between grasping scores 242 may not justify the change in grasp geometries 212 even though a newer grasp geometry 212 has a higher score 242.

Referring now to FIG. 2C, in some examples, the grasp geometry generator 210 generates the grasp area 216. By generating the grasp area 216, the grasp geometry generator 210 translates the user selected two-dimensional area of interest (e.g., selected target object) into the grasp area 216 in the three-dimensional point cloud of sensor data 134. Specifically, the generation of the grasp area 216 allows the user 12 to interact with the two-dimensional image to instruct the robot 100 to perform an action in the three-dimensional environment 30. The grasp geometry generator 210 receives the user-selected target object from the UI 300 and sensor data 134 (e.g., three-dimensional point cloud). The user 12 selects the target object on the two-dimensional image on the UI 300 that corresponds to the three-dimensional point cloud of data 134 for the field of view Fv of the robot 100. The grasp geometry generator 210 projects a plurality of rays from the selected target object from the two-dimensional image onto the three-dimensional point cloud of sensor data 134. The grasp area 216 therefore corresponds to the area formed by the intersection of the projected rays and the three-dimensional point cloud of sensor data 134

In particular, the grasp geometry generator 210 projects the plurality of rays from one or more pixels of the selected target object. Each ray of the plurality of rays projected from the two-dimensional image to the three-dimensional point cloud represents a pixel of the selected target object. The collection of the plurality of rays in the three-dimensional point cloud represents the grasp area 216. By projecting a ray for each pixel from the selected target object, the grasp geometry generator 210 translates the two-dimensional area of interest for the user 12 (e.g., selected target object) to the three-dimensional grasp area 216. Stated differently, the grasp area 216 designates a three-dimensional area that includes the target object such that the grasping system 200 may generate a grasp geometry 212 to grasp the three-dimensional target object within the grasp area 216. This means that the grasp area 216 designates an area of interest for the robotic manipulator to grasp. From this identified grasp area 216, the grasp geometry generator 210 may use the sensor data 134 within the boundaries of the identified grasp area 216 to understand the target object (e.g., the contour of the target object represented by the 3D point cloud sensor data 134) and to determine the grasp geometry 212.

In some examples, instructing the end-effector 150 of the robotic manipulator to grasp the target object within the grasp area 216 based on the grasp geometry 212 includes the one or more controllers 172 instructing the body 110 of the robot 100 to pitch toward the target object. That is, the one or more controllers 172 may instruct both the end-effector 150 of the robot 100 to maneuver towards the target object and the body 110 of the robot 100 to pitch towards the target object. By instructing both the end-effector 150 and the body 110, the robot 100 may generate more degrees of freedom that the end-effector 150 of the robotic manipulator can access.

In other examples, the one or more controllers 172 instruct a first leg 120 of the robot 100 to rotate an upper member 122U of the first leg 120 about a knee joint Jₖ towards a lower member 122L of the first leg 120. For example, the one or more controllers 172 instructs each leg 120 of the robot 100 to rotate the upper member 122U of the leg about the knee joint Jₖ towards the lower member 122_{L} to lower the body 110 of the robot 100. In this example, when the one or more controllers 172 instruct each leg 120 of the robot 100, the body 110 of the robot 100 lowers while the pitch of the body 110 remains constant. In another example, the one or more controllers 172 instruct a subset of the legs 120 of the robot 100 to rotate the upper member 122U of the leg 120 about the knee joint Jₖ towards the lower member 122L. Here, the body 110 of the robot 100 may pitch towards the target object while the body 110 of the robot lowers towards the ground surface 14.

Although the grasping system 200 of the robot 100 may be an efficient way to automatically grasp an object selected by a user 12. This ease of use feature may have limitations if the user 12 desires a very particular grasp geometry 212 to grasp the target object. For instance, the user 12 may instruct the robot 100 to perform subsequent actions on the selected object after performing an initial action. For example, the user 12 first instructs the robot 100 to grasp a valve and then subsequently instructs the robot 100 to turn the valve. In another example, the user 12 first instructs the robot 100 to grasp a switch and then subsequently instructs the robot 100 to flip the switch.

In these subsequent action examples, the user 12 may prefer to not be at the whim of an automatic grasping system. That is, with an automatic system the position and orientation that the automatic system of the robot 100 determines to grasp the object may be unable to perform subsequent actions that the user 12 desires the robot 100 to perform. For example, the automatic system of the robot 100 determines a position and orientation to grasp a valve that is unable to perform the subsequent action of turning the valve. Here, the limited range of motion of the robot 100 prevents the robot 100 from performing the subsequent action of turning the valve with the grasping position and orientation that the automatic system generated. The automatic system of the robot 100 may not grasp the valve in a position and orientation that allows the robot 100 to subsequently turn the valve because the robot 100 is unaware of the subsequent action the user 12 intends to perform when the automatic system generates the valve-grasping maneuver. The scenarios highlight the fact that the automated system may have its setbacks when the user 12 wants the robotic manipulator to behave in a particular way when grasping the target object.

To address these setbacks, implementations herein are directed towards a user interface (UI) for autonomous grasping that allows users 12 to instruct a robot 100 to grasp objects with a specific position and orientation. The user interface presents the position and orientation for an end-effector 150 of a robotic manipulator to grasp objects in an intuitive manner. Here, a sensor system 130 of the robot 100 receives sensor data 134 that corresponds to the environment 10 about the robot 100. The sensor data 134 is displayed for a user 12 of the robot 100 on a user interface in a two-dimensional representation that allows the user 12 to select a target object within the environment 10 of the robot 100. Additionally, the user 12 may provide grasping inputs to the user interface that constrain the pose for an end-effector 150 of a robotic manipulator. The pose for the end-effector 150 of the robotic manipulator represents both the position (e.g., x-direction, y-direction, and z-direction) and orientation (e.g., pitch, roll, and yaw) of the end effector 150. The robot 100 generates a three-dimensional location of the target object based on the received sensor data 134 and location that corresponds to the selected target object and grasping inputs. A control system 170 of the robot 100 instructs the end-effector 150 of the robotic manipulator to grasp the target object with the user 12 provided position and orientation based on the three-dimensional location of the target object.

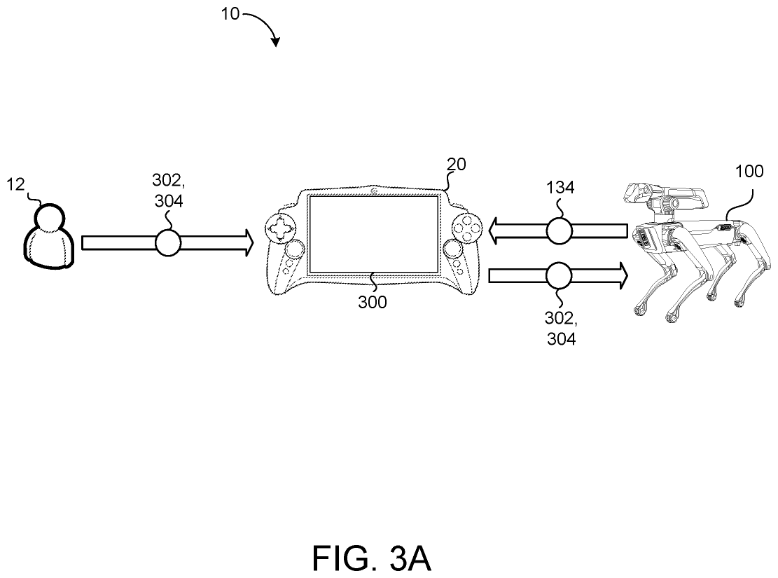

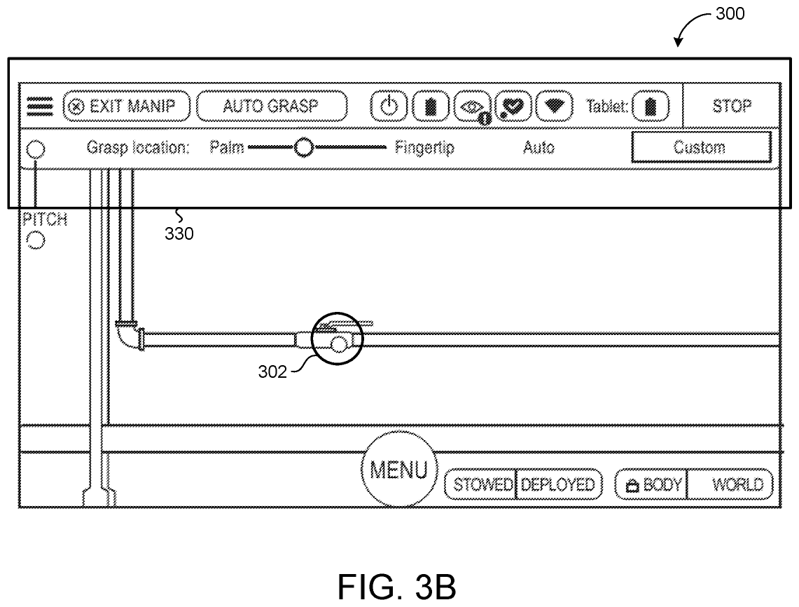

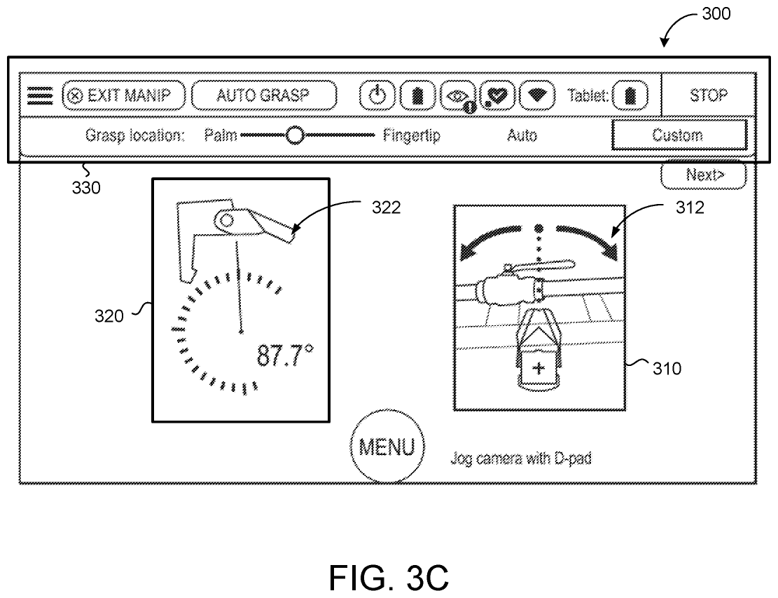

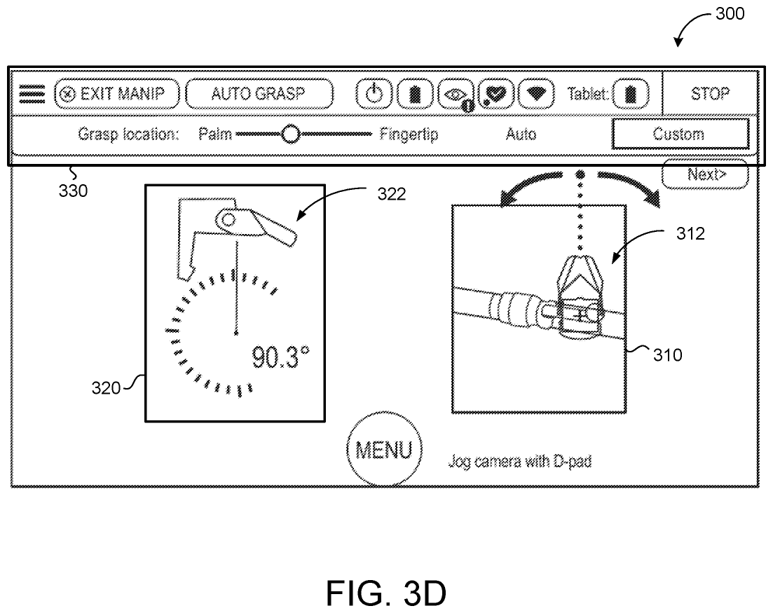

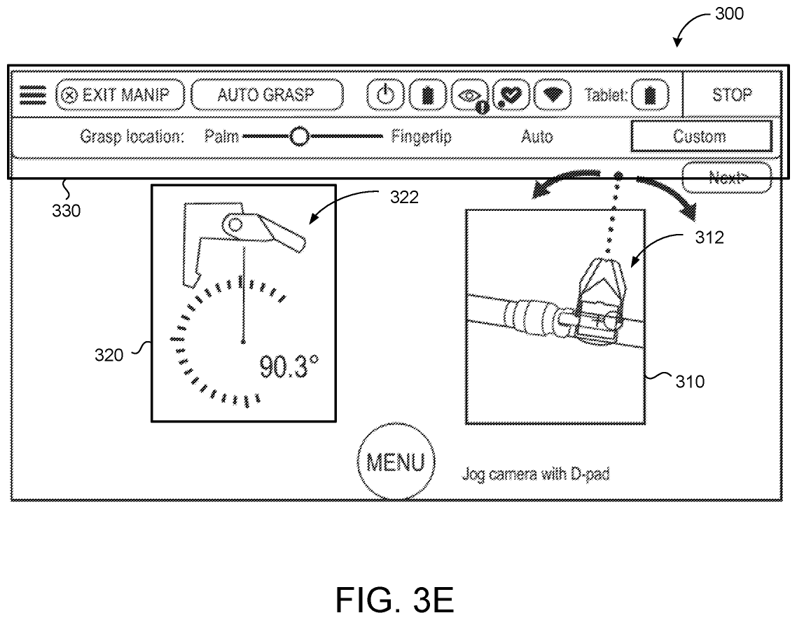

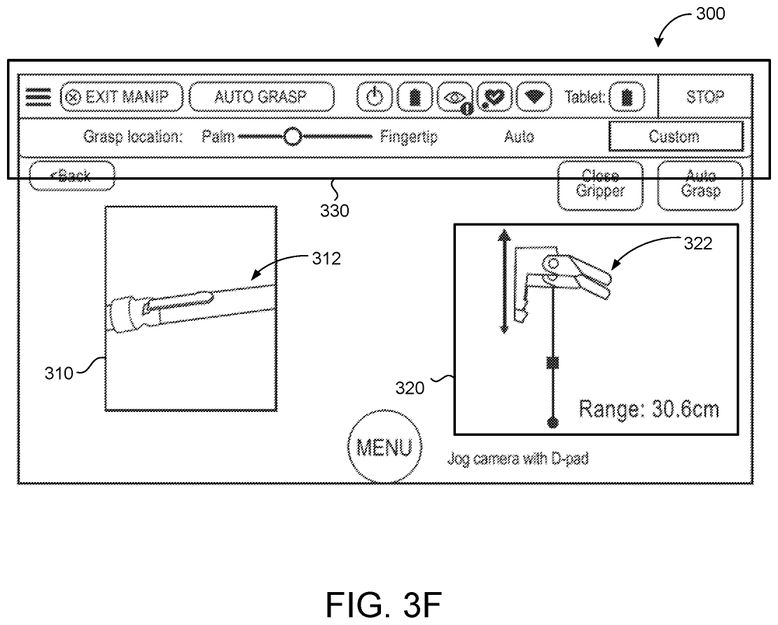

Referring now to FIG. 3A, in some implementations, the sensor system 130 of the robot 100 receives sensor data 134 for an area within an environment 10 about the robot 100. The robot 100 sends the sensor data 134 from the sensor system 130 to a remote controller 20 that displays an image that corresponds to the sensor data 134 on the UI 300. The imaged displayed on the UI 300 is a two-dimensional (2D) image that corresponds to the area within the environment 10 about the robot 100. In particular, the image is a 2D representation of the three-dimensional (3D) environment 10 about the robot 100.

The user 12 interacts with the UI 300 by providing a user input to the UI 300 that selects a location within the 2D representation of the area. The location selected by the user 12 corresponds to a position of a target object 302 within the area. Additionally, the user 12 interacts with the UI 300 by providing a plurality of grasping inputs 304 for an end-effector 150 of the robot 100. The grasping inputs 304 define the translation and orientation (e.g., pose) for the end-effector 150 of the robotic manipulator to grasp the target object 302. In some implementations, the plurality of grasping inputs 304 correspond to a plurality of constraints on one or more degrees of freedom for the end-effector 150 of the robotic manipulator. The one or more degrees of freedom may include a pitch of the end-effector 150, a roll of the end-effector 150, a yaw of the end-effector 150, a first translation in an x-direction, and a second translation in a y-direction. The one or more degrees of freedom may further include a third translation in a z-direction. Here, the translation (e.g., in the x-direction, y-direction, and/or z-direction) and the orientation (the pitch, yaw, and/or roll) of the end-effector 150 may correspond to a coordinate system local to the end-effector 150 (e.g., shown in FIG. 1A). The remote controller 20 communicates the selected target object 302 and plurality of grasping inputs 304 to the robot 100.

The sensor system 130 of the robot 100 generates a 3D location of the target object 302 based on the received sensor data 134, location that corresponds to the user-selected target object 302, and the grasping inputs 304. That is, the robot 100 generates the 3D location of the target object 302 based on the user 12 selecting the target object 302 on the 2D image representation of the sensor data 134 displayed on the UI 300. For example, the robot 100 receives the user-selected target object 302 from the 2D image and generates the 3D location that corresponds to the location of the selected target object 302 within the environment 10. The one or more controllers 172 of the robot 100 instruct the end-effector 150 of the robotic manipulator to grasp the target object 302 at the generated 3D location based on the plurality of grasping inputs 304 that designate the orientation and the translation (e.g., pose) for the end-effector 150 of the robotic manipulator.

Referring now to FIGS. 3A-3F, in some examples, the UI 300 includes a first window 310 and a second window 320. The first window 310 of the UI 300 includes a viewport that displays a 2D image 312 corresponding to the sensor data 134 for the area within the environment 10 about the robot 100 that includes the target object 302. The second window 320 includes a graphical icon 322 that represents the end-effector 150 of the robotic manipulator. Although FIG. 3C illustrates the second window 320 as being separate from the first window 310, in some examples, the content of the second window 320 may be included within the first window 310 (e.g., configured to be overlain on the 2D image 312 displayed in the first window 310). In some implementations, the graphical icon 322 represents a means to designate a first orientation for the end-effector 150. In the specific example of FIG. 3B, the graphical icon 322 includes a wire-frame representation of the end-effector 150 as the means to designate the first orientation for the end-effector 150. Here, the graphical icon 322 also includes a radial dial associated with the wire-frame representation of the end-effector 150 such that the user 12 may generate the first orientation by moving the wire-frame representation to a particular location on the radial dial. For example, where the first orientation represents the pitch of the end-effector 150, the radial dial designates the pitch for the end-effector 150 of the robotic manipulator. The graphical icon 322 is capable of being manipulated by the user 12 (e.g., rotated along the radial dial to a particular degree) to indicate the first grasping input 304 that designates the first orientation for the end-effector 150 of the robotic manipulator. That is, the user 12 may manipulate the radial dial to the desired pitch for the end-effector 150 to input the first grasping input 304 into the UI 300. In this respect, the first grasping input 304 identifies a first orientation at which the end-effector 150 should grasp the target object 302.

In some examples, the UI 300 also includes a third window 330 with a menu of options that may influence some portion of the functionality of the end-effector 150 of the robotic manipulator (e.g., influences how the end-effector 150 grasps the target object 302). For example, these menu options may be used by the user 12 to toggle through different types of grasping modes or features of the various grasping modes at the controller 20. In some configurations, such as FIG. 3C, the third window 330 is a completely separate window from both the first window 310 and the second window 320. In some implementations, the menu includes a plurality of user-selectable options. The user-selectable options may include a first option (e.g., a first selectable button) to initiate a grasping mode, a second option (e.g., a second selectable button) to initiate a custom grasp mode for the end-effector 150, and/or a third option (e.g., a third selectable button) to initiate an automatic grasp for the target object 302. Here, the selectable-option for the automatic grasp mode allows the user 12 to select a target object 302 and the robot 100 automatically grasps the selected target object 302 (e.g., using the automatic grasping process of the grasping system 200). In contrast, the option for the manual grasp mode of the target object 302 allows the user 12 to initiate a custom grasping process that enables the user 12 to select (or designate) the grasping inputs 304 that control how the end-effector 150 of the robotic manipulator grasps the target object 302.

In some examples, the UI 300 updates the 2D image 312 displayed to the user 12 at the controller 20 after receiving each grasping input 304. For instance, after the user 12 inputs a grasping input 304, the end-effector 150 may move according to the grasping input 304. This move by the end-effector 150 may, in turn, generate new or updated sensor data 134 (e.g., especially when the sensor 132 generating the sensor data 134 is located on the end-effector 150) which is displayed at the UI 300 as a new or updated 2D image 312. Here, when the 2D image representing the sensor data 134 is displayed in the viewport of the first window 310, user 12 will be able to visualize the new or updated 2D image 312 at the viewport. By updating the viewport image 312 after receiving each grasping input 304, the UI 300 provides the user 12 with visual feedback after the end-effector 150 of the robotic manipulator maneuvers to each grasping input 304 (e.g., pitches, rolls, yaws, or translates in a particular direction). Moreover, allowing the user 12 to select or to input each grasping input 304 in 2D images 312 at the UI 300 (e.g., at the two-dimensional viewport image 312) may allow the user 12 to avoid interacting with a more complicated 3D space to designate the grasping inputs 304. In particular, selecting the grasping inputs 304 from three-dimensional representations is often difficult for users 12 because changing one of the grasping inputs 304 may invalidate the previously provided grasping inputs 304. In 3D space, this becomes less intuitive for an user 12, especially a user 12 who may not be accustom to thinking or inputting constraints in a three-dimensional manner. For example, the position of a grasp (e.g., x-direction, y-direction, and z-direction) that instructs a robot 100 to grasp a target object 302 from a top orientation is different than a position of a grasp that instructs the robot 100 to grasp the target object 302 from a side orientation. Thus, if the user 12 first provides the position to the end-effector 150, a subsequent change of the orientation of the end-effector 150 may invalidate the previously provided position for the end-effector 150. In contrast, by sequentially prompting the user 12 to provide each grasping input 304 while having visual feedback in the two-dimensional viewport image 312, the UI 300 is able to prevent the user 12 from inadvertently invalidating any previously provided grasping inputs 304. Moreover, the user 12 may be able to quickly and/or to efficiently recognize if grasping inputs 304 are constraining the manual grasp of the target object 302 in the manner that he or she expected.

In some implementations, the user 12 provides the plurality of grasping inputs 304 by providing a first grasping input 304 that designates a first orientation for the end-effector 150 of the robotic manipulator to grasp the target object 302. Here, the first orientation may include one of a pitch or a roll for the end-effector 150 of the robotic manipulator to grasp the target object 302. In response, the end-effector 150 maneuvers to the first orientation and the one or more sensors 132 of the robot 100 generate sensor data 134 that corresponds to the field of view Fv at the first orientation. The robot 100 sends the sensor data 134 that corresponds to the field of view Fv at the first orientation to the UI 300 that displays the two-dimensional viewport image 312 corresponding to the first of view Fv at the first orientation. The user 12 may then provide a second grasping input 304 that designates a second orientation for the end-effector 150 of the robotic manipulator based on the modified viewport image 312 at the first orientation.

For example, a user 12 provides a first grasping input 304 to the UI 300 that designates a first orientation for a twenty degree pitch of the end-effector 150. The control system 170 of the robot 100 instructs the end-effector 150 to maneuver to the twenty-degree pitch as the first orientation. As the end-effector 150 of the robotic manipulator maneuvers to the first orientation (e.g., twenty degree pitch), the one or more sensors 132 generate sensor data 134 that corresponds to the field of view Fv of the end-effector 150 at the first orientation. The robot 100 sends the sensor data to the UI 300 that displays the viewport image 312 that corresponds with the field of view Fv of the end-effector 150 at the first orientation. The user 12 may then provide the second grasping input 304 that designates the second orientation to the UI 300 based on the viewport image 312 that displays the field of view Fv at the first orientation. For example, the user 12 provides a second grasping input 304 that designates a second orientation for a sixty-five degree roll of the end-effector 150 from the viewport image 312 that is displaying the twenty degree pitch. The control system 170 of the robot 100 instructs the end-effector 150 to maneuver to the second orientation (e.g., sixty-five degree roll) while maintaining the first orientation (e.g., twenty degree pitch). That is, the control system 170 executes the second grasping input 304 without invalidating the previously provided first grasping input 304.

In some implementations, the UI 300 overlays, on the viewport image 312, a representation of the end-effector 150 (e.g., wire frame representation of the end-effector 150) at the first orientation designated by the first grasping input 304. For example, after the end-effector 150 maneuvers to the first orientation and the UI 300 displays the sensor data 134 that corresponds to the field of view Fv at the first orientation, the UI 300 overlays the wire frame representation of the end-effector 150 on the viewport image 312. The overlain representation of the end-effector 150 corresponds to the current pose (e.g., at the first orientation) of the end-effector 150 in relation to the target object 302. The user 12 may manipulate the overlain representation of the end-effector 150 at the first window 310 to provide the second grasping input 304. In particular, the user 12 can manipulate the overlain representation to provide a second grasping input 304 for the end-effector 150. By manipulating the representation of the end-effector 150 at the first window 310, the user 12 gets a 2D visual representation of the end-effector 150 in relation to the target object 302 for the second grasping input 304.

The UI 300 and/or grasping system 200 may derive one or more grasping inputs 304 without explicit input as to that particular grasping input 304 from the user 12. In some implementations, the robot 100 derives one or more grasping inputs 304 based on the position of the robot 100. In particular, the robot 100 derives the grasping inputs 304 based on the position of the robot 100 relative to the target object 302. In some examples, the robot 100 derives the grasping inputs 304 based on a prior position of the robot 100 relative to the target object 302 before the user 12 selects the target object 302. In other examples, the robot 100 derives the one or more grasping inputs 304 based on a position of the robot 100 relative to the target object 302 after the user 12 selects the target object 302. That is, the robot 100 moves to a new position relative to the target object 302 after the user 12 selects the target object 302, and the robot 100 uses the new position to derive the grasping inputs 304. For example, the user 12 selects the target object 302 on the UI 300 and the robot 100 moves to a new position relative to the target object 302. In this example, once the robot 100 moves to the new position relative to the target object 302, the UI 300 and/or grasping system 200 may use the new position to derive a grasping input 304 that designates a yaw orientation of the end-effector 150. In either case, based on the position of the robot 100 relative to the target object 302, the robot 100 derives the yaw orientation of the end-effector 150 of the robotic manipulator to grasp the target object 302. The derived yaw orientation may therefore form a constraint for the degree of the freedom corresponding to yaw when the end-effector 150 grasps the target object 302. The user 12 may provide the remaining grasping inputs 304 either before or after the robot 100 (e.g., the UI 300 and/or grasping system 200) derives the yaw orientation. The derived orientation of the end-effector 150 is a non-limiting example, the robot 100 may derive any of the plurality of grasping inputs 304 (e.g., any position or orientation of the end-effector 150) based on the position of the robot 100 relative to the target object 302.

Referring to FIG. 3B, the sensor system 130 of the robot 100 receives sensor data 134 for the area within the environment 10 of the robot 100. The robot 100 sends the sensor data 134 to the remote controller 20 that displays the sensor data 134 as a two-dimensional representation. The user 12 selects the target object 302 from the two-dimensional representation displayed on the UI 300 at the remote controller 20. Specifically, the user 12 provides a user input to the 2D representation that selects the location corresponding to the position of the target object 302. The remote controller 20 sends the selected target object 302 to the robot 100 (e.g., to the grasping system 200 of the robot 100). The robot 100 derives the yaw orientation of the end-effector 150 based on the position of the robot 100 in relation to the selected target object 302. The user 12 then provides the plurality of grasping inputs 304 that corresponds to one or more degrees of freedom for the end-effector 150 of the robotic manipulator.

Referring to FIG. 3C, the user 12 provides the first grasping input 304 that designates the first orientation for the pitch of the end-effector 150. For example, the user 12 manipulates the radial dial of the graphical icon 322 in the second window 320 to designate the first orientation that corresponds to the pitch of the end-effector 150 (e.g., shown as a pitch of 87.7 degrees). The remote controller 20 sends the first grasping input 304 (e.g., first orientation) to the control system 170 that instructs the robot 100 to maneuver the end-effector 150 to a position (or pose) corresponding to the first grasping input 304. After the end-effector 150 maneuvers to a position (or pose) corresponding to the first grasping input 304, the robot 100 sends the sensor data 134 from the one or more sensors 132 that corresponds to the field of view Fv of the end-effector 150 at the first orientation to the remote controller 20. The UI 300 displays the viewport image 312 in the first window 310 that corresponds to the sensor data 134 at the first orientation to the user 12.

Referring to FIG. 3D, in some examples, the user 12 provides the second grasping input 304 that designates a first translation that corresponds to an x-direction and a y-direction of the end-effector 150. In other examples, the second grasping input 304 designates a first translation that corresponds only to the x-direction or only to the y-direction. The user 12 may provide the second grasping input 304 by manipulating the representation of the end-effector 150 at the first window 310 to the designated first translation (e.g., x-direction and y-direction). The representation of the end-effector 150 moves relative to the viewport image 312 at the first window 310 to assist the user 12 in visualizing the first translation position of the end-effector 150 relative to the target object 302. The remote controller 20 sends the second grasping input 304 to the control system 170, which, in turn, instructs the robot 100 to maneuver the end-effector 150 to the first translation of the x-direction and y-direction. The control system 170 instructs the end-effector 150 of the robot 100 to maneuver to the first translation while maintaining the first orientation of the end-effector 150. That is, after the end-effector 150 of the robotic manipulator maneuvers to the first translation, the end-effector 150 is at a pose that includes the first orientation (e.g., pitch of the end-effector 150) and the first translation (e.g., x-direction and y-direction of the end-effector 150). Specifically, the control system 170 instructs the end-effector 150 of the robotic manipulator to maneuver to the first translation (e.g., second grasping input 304) while the first orientation (e.g., first grasping input 304) of the end-effector 150 remains valid. The robot 100 sends the sensor data 134 from the one or more sensors 132 that corresponds to the field of view Fv of the end-effector 150 at the first orientation and first translation to the remote controller 20. The UI 300 displays the viewport image 312 that corresponds to the sensor data 134 at the first orientation and first translation to the user 12. When comparing FIGS. 3C and 3D, the combination of these figures indicates the sequence described where the user 12 first sets the pitch of the end-effector 150 using the radial dial of the graphical icon 322 in FIG. 3C and then the user 12 dictates the x and y translation of the end-effector 150 at the particular pitch using a selectable graphical representation of the end-effector 150 overlain on the viewport image 312 in FIG. 3D.

Referring to FIG. 3E, in some implementations, the user 12 provides a third grasping input 304 that designates a second orientation that corresponds to the rotation of the end-effector 150. The user 12 provides the third grasping input 304 that designates the second orientation by manipulating the overlain graphical representation of the end-effector 150 at the first window 310. The overlain representation of the end-effector 150 moves relative to the viewport image 312 as the user 12 manipulates the representation of the end-effector 150 to assist the user 12 in visualizing the second orientation of the end-effector 150 relative to the target object 302. The remote controller 20 sends the third grasping input 304 to the control system 170 that instructs the robot 100 to maneuver the end-effector 150 to a position (or pose) that integrates the third grasping input 304 that designates the second orientation for the end-effector 150 (e.g., the roll of the end-effector 150). The control system 170 instructs the end-effector 150 of the robot 100 to maneuver to a position (or pose) that integrates the third grasping input 304 while maintaining the first orientation and the first translation of the end-effector 150. That is, after the end-effector 150 of the robotic manipulator maneuvers to a position incorporating the third grasping input 304, the end-effector 150 is at a pose that includes the first orientation (e.g., pitch of the end-effector 150), the first translation (e.g., x-direction and y-direction of the end-effector 150), and second orientation (e.g., roll of the end-effector 150). The robot 100 sends the sensor data 134 from the one or more sensors 132 that corresponds to the field of view Fv of the end-effector 150 at the pose that includes the first orientation, the first translation, and the second orientation. The UI 300 displays the viewport image 312 that corresponds to the sensor data 134 at the first orientation, first translation, and second orientation to the user 12 at the controller 20.

Referring to FIG. 3F, the user 12 may provide a fourth grasping input 304 that designates a second translation that corresponds to the z-direction of the end-effector 150. In some examples, the user 12 chooses to manually provide the second translation that corresponds to the z-direction by selecting an option (e.g., button or icon) in the third window 330 of the UI 300. When the user 12 selects the manual mode by selecting the manual option, the user 12 provides the second translation that corresponds to the z-direction by manipulating the graphical icon 322 in the second window 320 of the UI 300. That is, the user 12 may interact with the graphical icon 322 of the end-effector 150 to provide the designated z-direction of the end-effector 150 to grasp the target object 302. As can be seen comparing the second window 320 of FIG. 3F with the second window 320 of FIG. 3C, the second window 320 may display different graphical icons 322 that assist the user 12 to input a particular orientation or translation for the end-effector 150. When the user 12 inputs the fourth grasping input 304 (e.g., the z-direction of translation), the remote controller 20 sends the fourth grasping input 304 (e.g., z-direction) to the control system 170 that instructs the robot 100 to maneuver the end-effector 150 to a position (or pose) that incorporates the fourth grasping input 304. The remote controller 20 sends the fourth grasping input 304 to the control system 170 that instructs the robot 100 to maneuver the end-effector 150 to a position (or pose) integrating the fourth grasping input 304, which designated the z-direction translation for the end-effector 150. The control system 170 instructs the end-effector 150 of the robot to maneuver to a position or pose incorporating the fourth grasping input 304 while maintaining the first orientation, the first translation, the second orientation, and the second translation of the end-effector 150. That is, after the end-effector 150 of the robotic manipulator maneuvers to a position embodying the fourth grasping input 304, the end-effector 150 is at a pose that includes the first orientation (e.g., pitch of the end-effector 150), the first translation (e.g., x-direction and y-direction of the end-effector 150), and second orientation (e.g., roll of the end-effector 150). When the end-effector 150 assumes this pose, the robot 100 sends the sensor data 134 from the one or more sensors 132 that corresponds to the field of view Fv of the end-effector 150 to the remote controller 20 for the user 12 to visualize. For example, the UI 300 displays the sensor data 134 for the field of view Fv at the assumed pose in the viewport image 312 of the first window 310. In other words, the viewport image 312 would display the sensor data 134 corresponding to the first orientation, first translation, second orientation, and second translation of the end-effector 150.

The control system 170 instructs the end-effector 150 of the robotic manipulator to grasp the target object 302 after the plurality of grasping inputs 304 are received or the sequence designed by the manual mode of the UI 300 is complete. In particular, after robot 100 derives the yaw of the end-effector 150 and receives the selected target object 302, the first orientation (e.g., pitch of the end-effector 150), the first translation (e.g., x-direction and y-direction of the end-effector 150), the second orientation (e.g., roll of the end-effector 150), and second translation (e.g., z-direction of the end-effector 150), the end-effector 150 of the robotic manipulator should be positioned in a grasping pose desired by the user 12. Thus, the control system 170 of the robot 100 instructs the end-effector 150 to grasp the target object 302 using this grasping pose.

In some examples, the user 12 selects for the UI 300 and/or grasping system 200 to automatically provide the second translation that corresponds to the z-direction for the end-effector 150. In the depicted UI 300, the user 12 selects the “auto grasp” icon or button located in the third window 330 of the UI 300 to indicate that the user 12 wants the grasping system 200 to automatically provide the second translation that corresponds to the z-direction for the end-effector 150. In some examples, the automatic option is restricted (i.e., the user 12 cannot select this option) until the UI 300 has received a particular set of grasping inputs 304 from the user 12. For instance, in the automatic option, the UI 300 requires that the user 12 has already provided the selected target object 302, the yaw orientation (may or may not be derived), the pitch orientation of the end-effector 150, the roll orientation of the end-effector 150, and the x-direction and y-direction translation for the end-effector 150. Given the plurality of these grasping inputs 304 already received or derived, the robot 100 (e.g., the grasping system 200 and/or the UI 300) may automatically generate the z-direction required to grasp the selected target object 302.

In some implementations, the user 12 requires the end-effector 150 of the robotic manipulator to grasp the target object 302 at a specific location of the end-effector 150. In particular, the user 12 instructs the end-effector 150 to grasp the target object 302 at an end (e.g., fingertips) of the end-effector 150, at the center (e.g., palm) of the end-effector 150, or at any point between the fingertips of the end-effector 150 and the palm of the end-effector 150. To designate the specific grasping or contact location on the end-effector 150, the user 12 may use a graphical icon included in the third window 330 of the UI 300. For example, FIG. 3F depicts the third window 330 including a graphical icon that the user 12 may select to adjust the grasp location on the end-effector 150. Here, the third window 330 includes a slidable icon that the user 12 may slide between a palm location on the end-effector 150 to a fingertip location on the end-effector in order to designate a precise contact location for the end-effector 150 to engage with the target object 302. For example, the user 12 adjusts the grasp location adjuster towards the fingertip grasp location such that the grasping inputs 304 (e.g., orientation and position) correspond to the fingertips of the end-effector 150. In another example, the user 12 adjusts the grasp location adjuster towards the palm grasp location such that the grasping inputs 304 correspond to the palm of the end-effector 150. Specifically, the grasp location adjuster allows the user 12 to provide which portion of the end-effector 150 (e.g., palm or fingertip) engages with the target object at the user provided orientation and position.

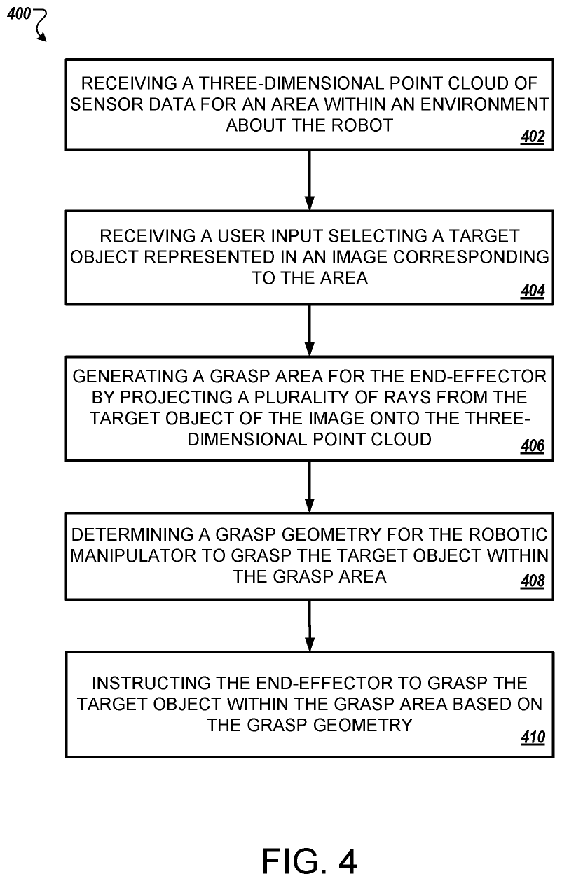

FIG. 4 is a flowchart of an example arrangement of operations for a method 400 of supervised autonomous grasping. The method 400 may be a computer-implemented method executed by data processing hardware 142 of the robot 100, which causes the data processing hardware 142 to perform operations. The method 400, at operation 402, includes receiving a three-dimensional point cloud of sensor data 134 for an area within an environment 30 about the robot 100. The method 400, at operation 404, includes receiving, from a user 12 of the robot 100, a user input selecting a target object represented in an image that corresponds to the area. The target object selected by the user input corresponds to a respective object for an end-effector 150 of a robotic manipulator of the robot 100 to grasp. The method, at operation 406, includes generating a grasp area 216 for the end-effector 150 of the robotic manipulator by projecting a plurality of rays 218 from the selected target object of the image onto the three-dimensional point cloud of sensor data 134. The method 400, at operation 408, includes determining a grasp geometry 212 for the robotic manipulator to grasp the target object within the grasp area 216. The method 400, at operation 410, includes instructing the end-effector 150 of the robotic manipulator to grasp the target object within the grasp area 216 based on the grasp geometry 212.

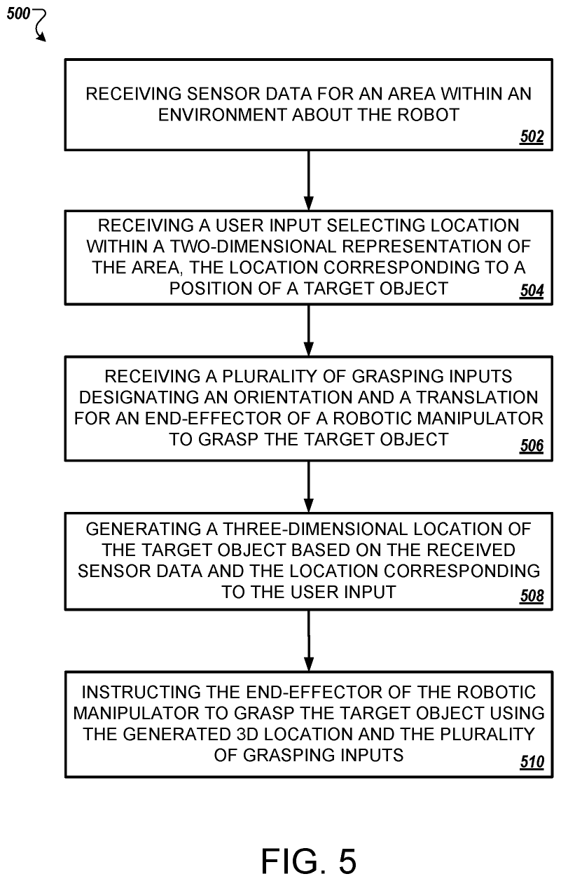

FIG. 5 is a flowchart of an example arrangement of operations for a method 500 for using a user interface 300 for supervised autonomous grasping. The method 500 may be a computer-implemented method executed by data processing hardware 142 of the robot 100, which causes the data processing hardware 142 to perform operations. The method 500, at operation 502, includes receiving sensor data 134 for an area within an environment 30 about the robot 100. The method 500, at operation 504, includes receiving, from a user 12 of the robot 100 at a user interface (UI) 300 in communication with the data processing hardware 142, a user input selecting a location within a two-dimensional (2D) representation of the area. The location corresponding to a position of a target object 302 within the area. The method 500, at operation 506, includes receiving, at the user interface 300 in communication with the data processing hardware 142, a plurality of grasping inputs 304 designating an orientation and a translation for an end-effector 150 of a robotic manipulator to grasp the target object 302. The method 500, at operation 508, includes generating a three-dimensional (3D) location of the target object 302 based on the received sensor data 134 and the location corresponding to the user input. The method 500, at operation 510, includes instructing the end-effector 150 of the robotic manipulator to grasp the target object 302 using the generated 3D location and the plurality of grasping inputs 304 designating the orientation and the translation of the end-effector 150 of the robotic manipulator.

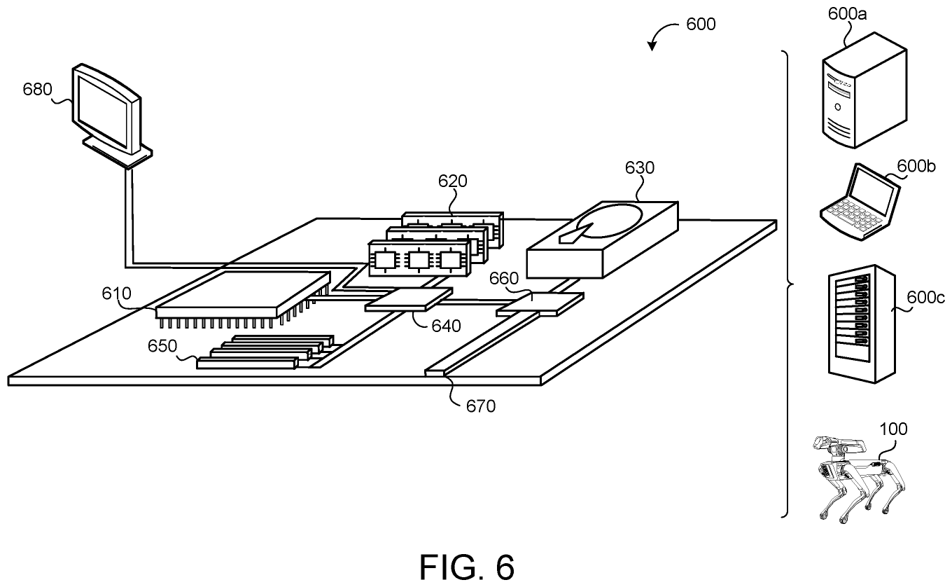

FIG. 6 is schematic view of an example computing device 600 that may be used to implement the systems and methods described in this document. The computing device 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 600 includes a processor 610 (e.g., data processing hardware), memory 620 (e.g., memory hardware), a storage device 630, a high-speed interface/controller 640 connecting to the memory 620 and high-speed expansion ports 650, and a low speed interface/controller 660 connecting to a low speed bus 670 and a storage device 630. Each of the components 610, 620, 630, 640, 660, and 660, are interconnected using various busses, and may be mounted on a common motherboard or in other manners as appropriate. The processor 610 can process instructions for execution within the computing device 600, including instructions stored in the memory 620 or on the storage device 630 to display graphical information for a graphical user interface (GUI) on an external input/output device, such as display 680 coupled to high speed interface 640. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 620 stores information non-transitorily within the computing device 600. The memory 620 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 630 is capable of providing mass storage for the computing device 600. In some implementations, the storage device 630 is a computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 620, the storage device 630, or memory on processor 610.

The high speed controller 640 manages bandwidth-intensive operations for the computing device 600, while the low speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port 670. The low-speed expansion port 670, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method when executed by data processing hardware of a robot causes the data processing hardware to perform operations comprising:
receiving sensor data for a space within an environment about the robot;
receiving, from a user interface (UI) in communication with the data processing hardware, a user input indicating a user-selection of a location within a two-dimensional (2D) representation of the space, the location corresponding to a position of a target object within the space;
receiving, from the UI, a plurality of grasping inputs designating an orientation and a translation for an end-effector of a robotic manipulator to grasp the target object;
generating a three-dimensional (3D) location of the target object based on the received sensor data and the location corresponding to the user input; and
instructing the end-effector of the robotic manipulator to grasp the target object using the generated 3D location and the plurality of grasping inputs designating the orientation and the translation of the end-effector of the robotic manipulator.

2. The method of claim 1, further comprising grasping, by the end-effector of the robotic manipulator, the target object.

3. The method of claim 1, wherein the plurality of grasping inputs corresponds to a plurality of constraints on one or more degrees of freedom for the end-effector of the robotic manipulator.

4. The method of claim 3, wherein the one or more degrees of freedom comprise a pitch of the end-effector, a roll of the end-effector, a first translation in an x-direction, and a second translation in a y-direction.

5. The method of claim 4, wherein the one or more degrees of freedom further comprises a third translation in a z-direction.

6. The method of claim 1, wherein receiving the plurality of grasping inputs designating the orientation and the translation for the end-effector of the robotic manipulator to grasp the target object comprises:
receiving a first grasping input designating a first orientation for the end-effector of the robotic manipulator to grasp the target object; and
instructing modification of a viewport image comprising the target object at the UI based on the designed first orientation for the end-effector of the robotic manipulator.

7. The method of claim 6, wherein the first orientation comprises one of a pitch or a roll for the end-effector of the robotic manipulator to grasp the target object.

8. The method of claim 6, wherein the UI comprises a first window and a second window separate from the first window, the first window comprising the viewport image displaying the sensor data for the space within the environment about the robot that includes the target object, the second window comprising a graphical icon representing the end-effector, the graphical icon capable of being user-manipulated to indicate the first grasping input designating the first orientation for the end-effector of the robotic manipulator to grasp the target object.

9. The method of claim 8, wherein the graphical icon comprises a wire-frame representation of the end-effector and a radial dial to designate a pitch as the first orientation for the end-effector of the robotic manipulator to grasp the target object.

10. The method of claim 8, further comprising:
overlaying, on the viewport image, a representation of the end-effector at the first orientation designated by the first grasping input; and
receiving, from the UI, a second grasping input designating a second orientation for the end-effector of the robotic manipulator to grasp the target object.

11. The method of claim 10, wherein the second orientation corresponds to a roll for the end-effector of the robotic manipulator to grasp the target object.

12. The method of claim 10, wherein receiving the second grasping input designating the second orientation comprises receiving another user input indicating another user-selection of the graphical icon indicating a roll for the end-effector of the robotic manipulator to grasp the target object.

13. A robot comprising:
a body;
a robotic manipulator coupled to the body, the robotic manipulator comprising an end-effector configured to grasp objects within an environment about the robot;
data processing hardware in communication with the robotic manipulator; and
memory hardware in communication with the data processing hardware, the memory hardware storing instructions that when executed on the data processing hardware cause the data processing hardware to perform operations comprising:
receiving sensor data for a space within an environment about the robot;
receiving, from a user interface (UI) in communication with the data processing hardware, a user input indicating a user-selection of a location within a two-dimensional (2D) representation of the space, the location corresponding to a position of a target object within the space;
receiving, from the UI, a plurality of grasping inputs designating an orientation and a translation for the end-effector of the robotic manipulator to grasp the target object;
generating a three-dimensional (3D) location of the target object based on the received sensor data and the location corresponding to the user input; and
instructing the end-effector of the robotic manipulator to grasp the target object using the generated 3D location and the plurality of grasping inputs designating the orientation and the translation of the end-effector of the robotic manipulator.

14. The robot of claim 13, wherein the operations further comprise grasping, by the end-effector of the robotic manipulator, the target object.

15. The robot of claim 13, wherein the plurality of grasping inputs corresponds to a plurality of constraints on one or more degrees of freedom for the end-effector of the robotic manipulator.

16. The robot of claim 15, wherein the one or more degrees of freedom comprise a pitch of the end-effector, a roll of the end-effector, a first translation in an x-direction, and a second translation in a y-direction.

17. The robot of claim 16, wherein the one or more degrees of freedom further comprises a third translation in a z-direction.

18. The robot of claim 13, wherein receiving the plurality of grasping inputs designating the orientation and the translation for the end-effector of the robotic manipulator to grasp the target object comprises:
receiving a first grasping input designating a first orientation for the end-effector of the robotic manipulator to grasp the target object; and
instructing modification of a viewport image comprising the target object at the UI based on the designed first orientation for the end-effector of the robotic manipulator.

19. The robot of claim 18, wherein the first orientation comprises one of a pitch or a roll for the end-effector of the robotic manipulator to grasp the target object.

20. The robot of claim 18, wherein the UI comprises a first window and a second window separate from the first window, the first window comprising the viewport image displaying the sensor data for the space within the environment about the robot that includes the target object, the second window comprising a graphical icon representing the end-effector, the graphical icon capable of being user-manipulated to indicate the first grasping input designating the first orientation for the end-effector of the robotic manipulator to grasp the target object.

21. The robot of claim 20, wherein the graphical icon comprises a wire-frame representation of the end-effector and a radial dial to designate a pitch as the first orientation for the end-effector of the robotic manipulator to grasp the target object.

22. The robot of claim 20, wherein the operations further comprise:
overlaying, on the viewport image, a representation of the end-effector at the first orientation designated by the first grasping input; and
receiving, from the UI, a second grasping input designating a second orientation for the end-effector of the robotic manipulator to grasp the target object.

23. The robot of claim 22, wherein the second orientation corresponds to a roll for the end-effector of the robotic manipulator to grasp the target object.

24. The robot of claim 22, wherein receiving the second grasping input designating the second orientation comprises receiving another user input indicating another user-selection of the graphical icon indicating a roll for the end-effector of the robotic manipulator to grasp the target object.
